(19) United States
(12) Patent Application Publication
(10) Pub. No.: US 2017/0364968 A1
(43) Pub. Date: Dec. 21, 2017

(54) METHOD AND SYSTEM FOR COST SHARING IN A POOLED VEHICLE

(71) Applicant: Conduent Business Services, LLC, Dallas, TX (US)

(72) Inventors: Ragavendran Gopalakrishnan, Bangalore (IN); Koyel Mukherjee, Bangalore (IN); Raja Subramaniam Thangaraj, Karur district (IN); Anumeha Rai, Jaipur (IN)

(21) Appl. No.: 15/183,827

(22) Filed: Jun. 16, 2016

(51) Int. Cl. G06Q 30/02; G01C 21/34; G06Q 50/30

(52) U.S. Cl. CPC G06Q 30/0283; G01C 21/3453; G06Q 50/30

(57) ABSTRACT

The disclosed embodiments illustrate methods and systems of cost sharing in a pooled vehicle. The method includes receiving, by one or more transceivers of a computing device, a detour distance to be traversed by the pooled vehicle to process a travel request, wherein the detour distance is determined by one or more sensors in the pooled vehicle. Further, the method includes determining, by one or more processors of the computing device, a first cost to be compensated to at least one first commuter in the pooled vehicle based on the received detour distance, wherein the first cost is incurred by a second commuter associated with the travel request.

### TECHNICAL FIELD

The presently disclosed embodiments are related, in general, to a travel management system. More particularly, the presently disclosed embodiments are related to methods and systems for cost sharing in a pooled vehicle.

### BACKGROUND

Recent developments in the field of travel management systems have led to the evolution of online platforms that may cater to various travelling requirements of a user. Usually, such travel management systems provide a travelling solution for public and/or private transportation services based on user preferences. Specifically, in case of private transportation services, ridesharing in pooled vehicles has emerged as a popular solution to combat ever-increasing congestion along road networks around the world.

Typically, ridesharing in the pooled vehicles specifies a routing scheme and a pricing scheme for commuters. In accordance with the routing scheme, classification of incoming commuter requests into ridesharing groups and subsequent computation of optimal routes are performed. In accordance with the pricing scheme, determining ride charges for every commuter travelling in a pooled vehicle depends on distance traveled by the commuter and a count of one or more commuters in the pooled vehicle associated with the traveled distance. However, such ridesharing in the pooled vehicles may not be dynamically adaptable in real-time so that unanticipated cancellations and new requests are accommodated. Further, the commuters end up paying more than an estimated cost because of detour distance and/or detour time caused due to subsequent pickups. Therefore, a robust method and system is needed to share cost among the one or more commuters travelling in the pooled vehicle.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for cost sharing in a pooled vehicle. The method includes receiving, by one or more transceivers of a computing device, a detour distance to be traversed by the pooled vehicle to process a travel request, wherein the detour distance is determined by one or more sensors in the pooled vehicle. The method further includes determining, by one or more processors of the computing device, a first cost to be compensated to at least one first commuter in the pooled vehicle based on the received detour distance, wherein the first cost is incurred by a second commuter associated with the travel request.

According to embodiments illustrated herein, there is provided a system for cost sharing in a pooled vehicle. The system includes one or more processors configured to operate one or more transceivers of a computing device to receive a detour distance to be traversed by the pooled vehicle to process a travel request, wherein the detour distance is determined by one or more sensors in the pooled vehicle. The one or more processors of the computing device are further configured to determine a first cost to be compensated to at least one first commuter in the pooled vehicle based on the detour distance, wherein the first cost is incurred by a second commuter associated with the request.

According to embodiments illustrated herein, there is provided a computer program product for use with a computing device. The computer program product comprises a non-transitory computer readable medium storing a computer program code for cost sharing in a pooled vehicle. The computer program code is executable by one or more processors in the computing device to operate one or more transceivers to receive a detour distance to be traversed by the pooled vehicle to process a travel request, wherein the detour distance is determined by one or more sensors in the pooled vehicle. The computer program code is further executable by the one or more processors to determine a first cost to be compensated to at least one first commuter in the pooled vehicle based on the detour distance, wherein the first cost is incurred by a second commuter associated with the request.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented, in accordance with at least one embodiment;

FIG. 2 is a block diagram that illustrates a user-computing device, in accordance with at least one embodiment;

FIG. 3 is a block diagram that illustrates an application server, in accordance with at least one embodiment;

FIG. 4 is a flowchart that illustrates a method of cost sharing in a pooled vehicle, in accordance with at least one embodiment;

FIGS. 5A and 5B are exemplary scenarios that illustrate a method of cost sharing in a pooled vehicle, in accordance with at least one embodiment;

FIG. 6 is a block diagram that illustrates a first exemplary GUI presented to a commuter on a user-computing device for raising a travel request, in accordance with at least one embodiment;

FIGS. 7A and 7B, collectively, represents a block diagram that illustrates a second exemplary GUI presented to a commuter on a user-computing device for displaying a first user interface, in accordance with at least one embodiment;

FIG. 8 is a block diagram that illustrates a third exemplary GUI presented to an operator of a pooled vehicle on a user-computing device for displaying a second user interface, in accordance with at least one embodiment; and

FIGS. 9A and 9B, collectively, represents a block diagram that illustrates a fourth exemplary GUI presented to a service provider of a pooled vehicle on an agent-computing device for displaying a third user interface, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “user-computing device” may refer to a computer, a device (that includes a processor/microcontroller and/or any other electronic component), or a system (that performs one or more operations to one or more programming instructions) associated with a commuter. The user-computing device may be geographical positioning system (GPS) enabled and capable of accessing (or being accessed by) a network, via wired or wireless communication capabilities. In an embodiment, the user-computing device may present a graphical user interface (GUI) to the commuter. Examples of the user-computing device may include, but are not limited to, a desktop computer, a laptop, a personal digital assistant (PDA), and a smartphone.

A “first commuter” may refer to an individual who may have availed a pooled vehicle for commuting between two locations along a route. In an embodiment, the first commuter may refer to an individual who is already travelling in the pooled vehicle when a new pickup request is received by an operator of the pooled vehicle. For example, a first user and a second user may be travelling in a pooled vehicle, when a travel request to pick up a third user is received by an operator of the pooled vehicle. In this scenario, both the first user and the second user may be referred to as the first commuter.

A “second commuter” may refer to an individual who raises a request to travel in a pooled vehicle between a two locations along a route. In an embodiment, the second commuter may raise the travel request using a user-computing device associated with him/her. In an embodiment, the second commuter may have to compensate one or more first commuters already travelling in the pooled vehicle for an inconvenience caused by the request of the second commuter. For example, a first user and a second user may be travelling in a pooled vehicle, when a request to pick up a third user is received by an operator of the pooled vehicle. In this scenario, the third user may correspond to the second commuter. Further, the second commuter (i.e., the third user) may have to pay a first cost to the one or more first commuters, i.e. the first user and the second user.

A “pooled vehicle” may refer to a private transportation vehicle shared by one or more commuters to travel between two or more locations along a route. For example, a first commuter may reserve a private transportation vehicle to travel from location “A” to location “B” and a second commuter may reserve the private transportation vehicle to travel from location “C” to the location “B.” In this scenario, the private transportation vehicle may be shared by the first commuter and second commuter to travel along a route (“A->C->B”), thus the private vehicle may be referred to as the pooled vehicle. Further, the cost of travel in the pooled vehicle may be shared between the first commuter and the second commuter.

A “vehicle-computing device” may refer to a computer, a device (that includes a processor/microcontroller and/or any other electronic component), or a system (that performs one or more operations to one or more programming instructions), installed in a vehicle (i.e., a pooled vehicle). The vehicle-computing device may be GPS enabled and capable of accessing (or being accessed by) a network, via wired or wireless communication capabilities. In an embodiment, the vehicle-computing device may present a GUI to an operator of the pooled vehicle. Examples of the vehicle-computing device may include, but are not limited to, a desktop computer, a laptop, a personal digital assistant (PDA), an in-vehicle infotainment (IVI) system, and a smartphone.

A “travel request” may correspond to a request raised by an individual to travel between a two locations along a route. In an embodiment, the travel request may comprise a source location, a destination location, and a time and day of travel. In an embodiment, the travel request may be pre-booking request. In another embodiment, the travel request may be real-time travel request.

A “detour distance” may refer to an extra distance traveled by a commuter on a vehicle due to deviation from a predetermined route. For example, a commuter may be travelling on a vehicle between location “A” and location “B” via a first route of “5 miles.” Due to a road blockage the vehicle may have to follow a second route between location “A” and location “B,” such that the second route may be of “7 miles.” In this scenario, the extra “2 miles” traversed by the commuter may correspond to the detour distance. In an embodiment, the vehicle, in which a first commuter is travelling, may correspond to a pooled vehicle. The first commuter in the pooled vehicle may have to travel an extra distance due to a subsequent pick up of a second commuter. In this scenario, the extra distance traveled by the first commuter in the pooled vehicle may correspond to the detour distance.

A “detour time” may refer to extra time spent by a commuter for travelling in a vehicle due to a deviation from a predetermined route, or in other words, due to traversal on a detour distance. For example, a commuter may be travelling on a vehicle between location “A” and location “B” via a first route of an estimated time of travel as “1 hour.” Due to a road blockage the vehicle may have to follow a second route between location “A” and location “B,” such that the second route may have an estimated time of travel as “1 hour 20 minutes.” In this scenario, the extra “20 minutes” spent by the commuter during the travel may correspond to the detour time. In an embodiment, the vehicle, in which the first commuter is travelling, may correspond to a pooled vehicle. The first commuter in the pooled vehicle may have to spend an extra time in travelling due to a subsequent pick up of a second commuter. In this scenario, the extra time spent by the first commuter in the pooled vehicle may correspond to the detour time.

A “cost” may refer to a price paid by a commuter to a service provider for availing a transportation facility offered by the service provider. In an embodiment, the transportation facility may correspond to a public vehicle or a private vehicle. In an embodiment, the private vehicle may further correspond to a pooled vehicle. In a scenario, when the transportation facility is for the pooled vehicle, the cost may be shared among the one or more commuters who availed the pooled vehicle. The cost may be a first cost, a second cost and/or a third cost, as explained hereinafter.

A “first cost” may refer to an incentive paid by a second commuter to a first commuter to compensate for a detour from a predetermined route associated with the first commuter. In an embodiment, the detour may be caused due to a travel request for pickup, raised by the second commuter. In an embodiment, the detour may correspond to a detour distance and a detour time. For example, a service provider may charge a base fare of “USD 2 per mile” and the detour distance caused by the pickup request of the second commuter may be “2 miles.” In this scenario, the second commuter may compensate the first commuter by paying “USD 4” for the extra “2 miles” traveled by the first commuter for the pickup of the second commuter. Thus, “USD 4” may correspond to the first cost paid to the first commuter by the second commuter. In an embodiment, the service provider may charge a base fare of “USD 3 per hour” and the detour time caused by the second commuter may be “20 minutes.” In this scenario, the second commuter may compensate the first commuter by paying “USD 1” for the extra “20 minutes” spent by the first commuter for the pickup of the second commuter. Thus, “USD 1” may correspond to the first cost paid to the first commuter by the second commuter.

A “second cost” may refer to an amount paid by a commuter to an operator of a pooled vehicle for availing a service of the pooled vehicle. In an embodiment, the second cost may be determined based on a distance traveled by each of the one or more commuters in the pooled vehicle and a count of the one or more commuters associated with the traveled distance. For example, a first commuter may travel a distance of “2 miles” in a pooled vehicle and later the first commuter shares the pooled vehicle with a second commuter for a distance of “1 mile.” In this scenario, the second cost paid by the first commuter is determined based on the distance of “2 miles” and the shared distance of “1 mile.” Further, the second cost paid by the second commuter may be determined based on the shared distance of “1 mile.”

A “third cost” may refer to a total cost incurred by a commuter to a service provider of a pooled vehicle. The third cost is determined based on a first cost and a second cost associated with the commuter.

A “first distance” may refer to a distance traveled by a first commuter in a pooled vehicle before a subsequent commuter, such as a second commuter, is picked up by the pooled vehicle. For example, a first commuter may board a pooled vehicle from a first location to travel to a second location on a first route. Further, the pooled vehicle may start a detour from a first node in the first route to process a subsequent pick up request of a second commuter. The second commuter may board the pooled vehicle from a second node. Thus, the distance traveled by the first user between the first location and the second node may correspond to the first distance.

A “second distance” may refer to a distance traveled by a first commuter on a pooled vehicle after the pooled vehicle has picked up a subsequent commuter, such as a second commuter. For example, the first commuter boards a pooled vehicle from a first location to travel to a second location on a first route. The pooled vehicle may detour from a first node in the first route to process a subsequent travel request of the second commuter. The second commuter may board the pooled vehicle from a second node. Thus, the distance traveled by the first commuter between the second node and the second location may correspond to the second distance.

A “commuter profile” may correspond to a profile associated with a commuter that includes one or more preferences pertaining to requirements of the commuter. In an embodiment, the commuter profile may be created by the commuter at the time of registration for a service (e.g., a pooled transportation service). In an embodiment, the commuter profile may comprise preference of one or more co-commuters, a first detour distance threshold, a cost per unit time parameter, a first waiting time threshold, a maximum count of intermediate hops, and/or a preference of make of the vehicle.

A “first detour distance threshold” may refer to a maximum detour distance that a first commuter is ready to travel in a vehicle (e.g., a pooled vehicle) for picking up another commuter, such as a second commuter. In an embodiment, a service provider of the pooled vehicle may have to cancel a travel request of the other commuter, if the detour distance caused by the travel request exceeds the first detour distance threshold, as specified by the first commuter.

A “cost per unit time parameter” may refer to a cost parameter specified by a commuter in his/her commuter profile. In an embodiment, the commuter, travelling in a pooled vehicle, may be compensated for a detour time caused due to processing of one or more subsequent travel requests by the pooled vehicle by utilizing the corresponding cost per unit time parameter.

A “first waiting time threshold” may refer to a time duration up to which a commuter may wait for a vehicle (e.g., a pooled vehicle) at a location associated with a travel request raised by the commuter. In an embodiment, the vehicle may be selected for the request if the waiting time of the commuter for the vehicle is less than the first waiting time threshold. For example, Jack requested for a pooled vehicle for a travel from a first location to a second location along a first route at “10:30 a.m.” Further, Jack may have specified the first waiting time threshold as “15 minutes.” In this scenario, the pooled vehicle that may reach the first location before “10:45 a.m.” may be selected for processing the travel request of Jack.

A “maximum count of intermediate hops” may refer to a constraint for a permissible count of hops that a vehicle (e.g., a pooled vehicle) can make while progressing along a route. In an embodiment, the maximum count of intermediate hops may be specified by a commuter travelling in the pooled vehicle.

“One or more constraints” may refer to constraints specified by a service provider associated with a pooled vehicle. The one or more constraints may comprise a second detour distance threshold and/or a second waiting time threshold. In an embodiment, a pooled vehicle may be selected for processing a travel request only if the pooled vehicle satisfies the one or more constraints.

A “second detour distance threshold” may refer to a maximum detour distance that an operator (e.g., a driver) of a vehicle may traverse for processing a travel request raised by a commuter. In an embodiment, the operator of the vehicle may not accept a travel request raised by the commuter, if the detour distance caused by the travel request exceeds the second detour distance threshold.

A “second waiting time threshold” may refer to a time duration up to which an operator (e.g., a driver) of a vehicle may wait at a pick up location associated with a travel request raised by a commuter. In an embodiment, the travel request of the commuter may be canceled if the commuter does not show up before the second waiting time threshold has lapsed. In an alternate embodiment, the commuter may be charged based on an extra time the driver has to wait after the second waiting time threshold has lapsed. For example, Jack requested for a pooled vehicle for a travel from a first location to a second location along a first route at “10:30 a.m.” Further, the driver of the pooled vehicle may have specified the second waiting time threshold as “15 minutes.” In this scenario, the driver of the pooled vehicle may wait up to “10:45 a.m.” for Jack. After “10:45 a.m.” the request of Jack may be canceled or Jack may be charged for extra waiting time after “10:45 a.m.”

An “estimated cost” may refer to a cost estimated by a service provider of a vehicle (e.g., a pooled vehicle) in response to a travel request raised by a commuter. The estimated cost may comprise a minimum cost and a maximum cost that may be incurred by the commuter, if the commuter chooses to travel in the pooled vehicle.

A “count of one or more commuters” may refer to a count of one or more commuters travelling in a pooled vehicle. For example, a first commuter may be travelling in a pooled vehicle between a first location and a second location on a first route. The pooled vehicle may start a detour from a first node in the first route to pick up a second commuter from a second node. Thus, the count of one or more commuters between the first location and the first node is one and the count of the one or more commuters from second node onwards is two.

A “route” refers to a path that may be traversed by a vehicle to pick up or drop one or more commuters along the route. In an embodiment, the route may include a set of “s” locations in a predetermined order. In an embodiment, the route may include at least two locations having one source location and one destination location. For example, a vehicle travels from Harlem to East Village in New York. Thus, the path from Harlem to East Village is a route with Harlem being a source location and East Village being a destination location.

A “capacity of a vehicle” refers to a maximum count of commuters that may be accommodated in a vehicle when the vehicle is empty. In an embodiment, the capacity of the vehicle corresponds to a maximum count of permissible vacancies in the vehicle. Thus, the capacity of the vehicle may correspond to a total count of seats in the vehicle. For example, a taxi driven by a driver can accommodate 4 commuters. This implies that the capacity of the taxi is 4.

A “base fare” may refer to a base price fixed by a service provider of a vehicle (i.e., a pooled vehicle). For example, a service provider may charge a commuter who may wish to travel in a vehicle associated with the service provider at a rate of “USD 2 per mile,” or “USD 8 per hour.” In this scenario, “USD 2 per mile” or “USD 8 per hour” may correspond to the base fare.

A “permissible detour area” may refer to an area that encompasses one or more locations, such that a vehicle (e.g., a pooled vehicle) travelling along a first route is permitted to detour from the first route to process a travel request that originated at a location of the one or more locations. In an embodiment, the permissible detour area may be determined based on a predefined criteria. In an embodiment, the predefined criteria may be defined by a service provider of the pooled vehicle. For example, for a location “I,” if “n” times a distance d(i, D), is less than or equal to a difference between a distance d(u, D) and a distance d(u, i), “i” may be considered a location that is within the permissible detour area. Here, “i” represents a location in the permissible detour area, “u” represents the current location of the pooled vehicle, “D” represents a destination location of the pooled vehicle, and “n” represents a numeric value specified by the service provider of the pooled vehicle, such as

$$n = 1 - \frac{1}{k} ,$$

when the location “i” represents a “k^{th}” pickup of the pooled vehicle and the location “u” represents a “k−1^{th}” pickup location of the pooled vehicle.

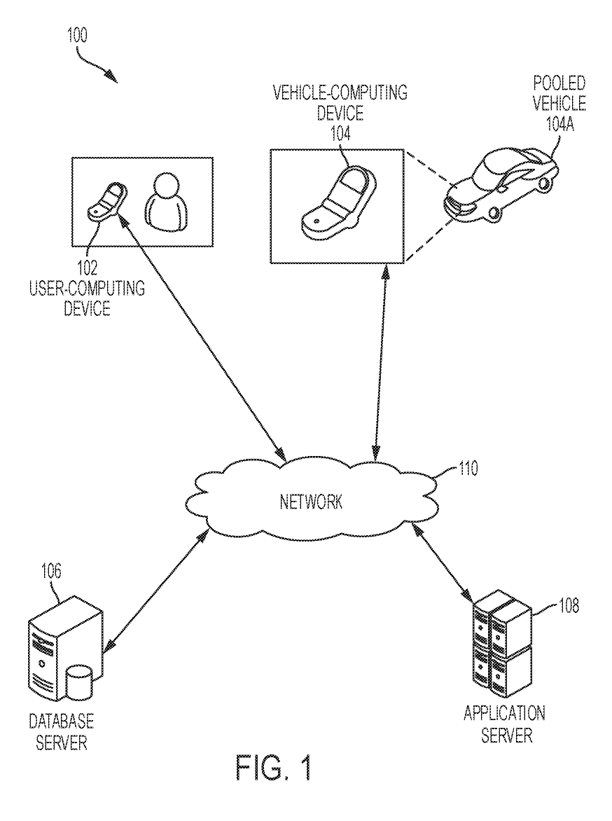

FIG. 1 is a block diagram of a system environment in which various embodiments may be implemented. With reference to FIG. 1, there is shown a system environment 100 that includes a user-computing device 102, a vehicle-computing device 104, a database server 106, an application server 108, and a network 110. Various devices in the system environment 100 may be interconnected, via the network 110.

In an embodiment, the user-computing device 102 may refer to a computing device associated with a commuter. The user-computing device 102 may include one or more processors and one or more memories. The one or more memories may include computer readable code that may be executable by the one or more processors to perform one or more operations as specified by the commuter. In an embodiment, the user-computing device 102 may include one or more sensors, such as, but not limited to, a Global Positioning System (GPS) sensor, a compass, and a Wi-Fi sensor. In an embodiment, the user-computing device 102 may have communication capabilities that enable the user-computing device 102 to transmit/receive data and messages to other devices, in accordance with one or more communication protocols such as, but are not limited to, FTP, WebDAV, E-Mail, SMB, NFS, and TWAIN.

In an embodiment, the commuter may utilize the user-computing device 102 for registration on a pooled transportation service platform. In an embodiment, the pooled transportation service platform may be associated with a service provider, such that the service provider may be associated with one or more pooled vehicles. During the registration, the commuter may be required to provide a commuter profile associated with him/her. The commuter may further utilize the user-computing device 102 to store the commuter profile on the database server 106. In an embodiment, the commuter profile may comprise at least a preference of one or more co-commuters, a first detour distance threshold, a cost per unit time parameter, a first waiting time threshold, a maximum count of intermediate hops, and/or a preference of make of the vehicle. For example, Table 1 illustrates a commuter profile, which corresponds to each of two commuters, stored in the database server 106.

TABLE 1
Illustration of the commuter profile of each of the two commuters

| Commuter id | Gender | Commuter preferences |
|---|---|---|
| Commuter-1 | Female | Preferred co-commuters: Females |
| | | First detour distance threshold: 4 miles |
| | | Cost per unit time parameter: USD 2 per hour |
| | | First waiting time threshold: 15 minutes |
| | | Maximum count of intermediate hops: 3 |
| | | Preferred make of the vehicle: Hatchback |
| Commuter-2 | Female | Preferred co-commuters: No preference |
| | | First detour distance threshold: 2 miles |
| | | Cost per unit time parameter: USD 4 per hour |
| | | First waiting time threshold: 25 minutes |
| | | Maximum count of intermediate hops: 4 |
| | | Preferred make of the vehicle: No preference |

A person having ordinary skill in the art will appreciate that the abovementioned table is for illustrative purpose and should not be construed limiting to the scope of the disclosure.

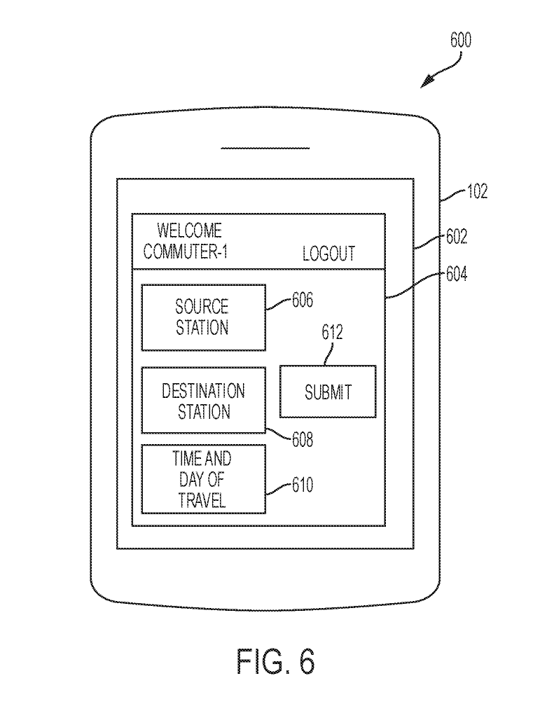

In an embodiment, the user-computing device 102 may present a GUI to the commuter for raising a travel request. The travel request may comprise two locations (i.e., a source location and a destination location) between which the commuter may wish to commute, and a time of travel. In an embodiment, a pickup location (i.e., the source location) of the commuter may correspond to a current location of the commuter. In an embodiment, the GPS sensor in the user-computing device 102 may determine the current location of the user. Further, the user-computing device 102 may transmit the travel request to the application server 108. In an embodiment, the GUI presented on the user-computing device 102 for raising the travel request has been described later in FIG. 6.

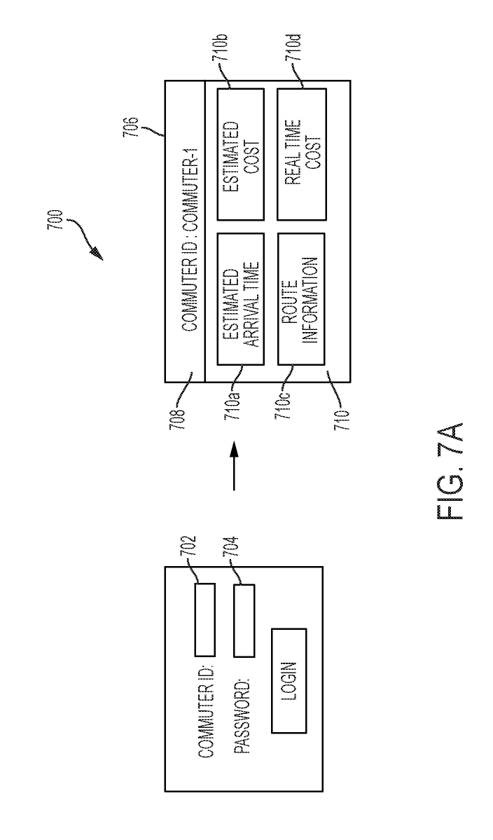

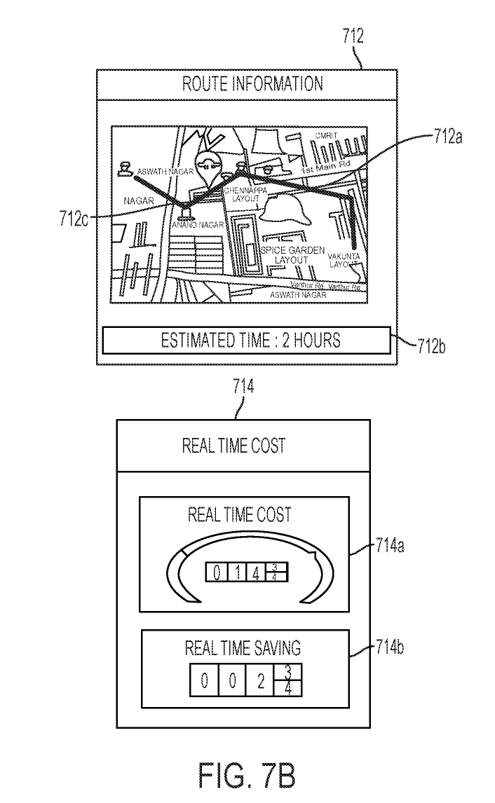

In an embodiment, when the travel request of the commuter is processed by the application server 108, the user-computing device 102 may receive a first user interface. In an embodiment, the first user interface may comprise an estimated time of arrival of the vehicle (i.e., a pooled vehicle from the one or more pooled vehicles), an estimated cost of travel, an estimated time of travel, a route information, and information pertaining to a real-time cost incurred by the commuter for travelling in the pooled vehicle. In an embodiment, the commuter may be able to view the information pertaining to the real-time cost only after the commuter is picked up by the pooled vehicle or the pooled vehicle may have detoured to pick up the commuter. Further, the commuter may utilize the user-computing device 102 to view the first user interface. In an embodiment, the user-computing device 102 may further display a current location of the pooled vehicle to the commuter. In an embodiment, a GUI for presenting the first user interface on the user-computing device 102 has been described later in FIGS. 7A and 7B.

In an embodiment, the user-computing device 102 may receive the real-time cost incurred by the commuter in the first user interface, for travelling in the pooled vehicle. In an embodiment, the commuter may correspond to a first commuter or a second commuter. The first commuter may refer to an individual who may be already travelling in the pooled vehicle along a first route, when a travel request is received by the vehicle-computing device 104 of the pooled vehicle. The second commuter may refer to an individual who may have raised the travel request for the pooled vehicle.

A person having ordinary skill in the art will understand that each of one or more commuters already travelling in the pooled vehicle may be referred to as the first commuter, when the travel request is received.

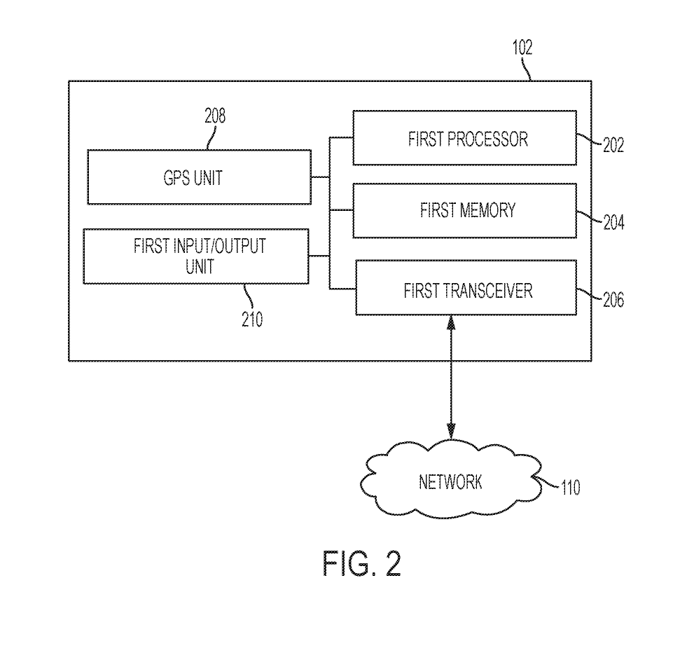

The user-computing device 102 may correspond to a variety of computing devices, such as, but not limited to, a laptop, a PDA, a tablet computer, a smartphone, and a phablet. In an embodiment, the block diagram of the user-computing device 102 has been described later in FIG. 2.

In an embodiment, the vehicle-computing device 104 may refer to a computing device installed in the vehicle (e.g., the pooled vehicle). The vehicle-computing device 104 may include one or more processors and one or more memories. The one or more memories may include computer readable code that may be executable by the one or more processors to perform one or more operations as specified by an operator (e.g., a driver) of the pooled vehicle. In an embodiment, the vehicle-computing device 104 may include one or more sensors, such as, but not limited to, a GPS sensor, a compass, and a Wi-Fi sensor. In an embodiment, the vehicle-computing device 104 may have communication capabilities that enable the vehicle-computing device 104 to transmit/receive data and messages to other devices, in accordance with one or more communication protocols, such as, but are not limited to, FTP, WebDAV, E-Mail, SMB, NFS, and TWAIN.

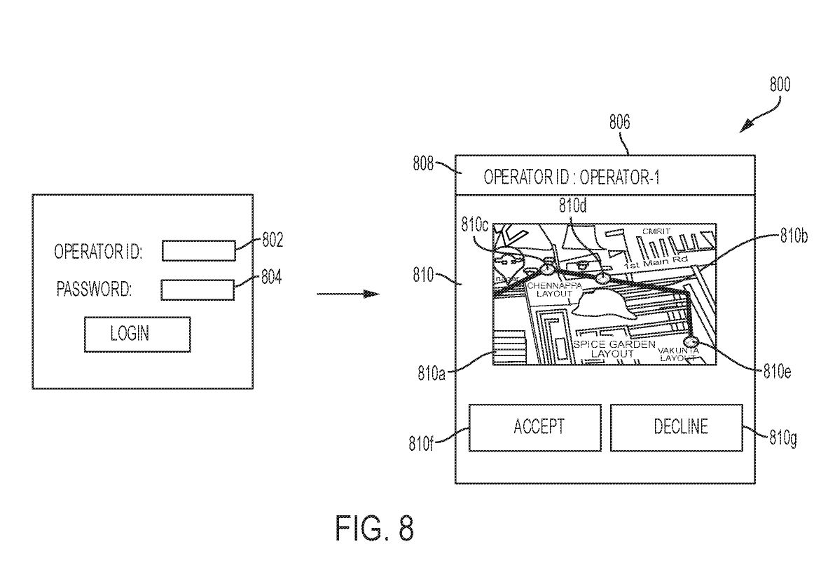

In an embodiment, the vehicle-computing device 104 may present a GUI (i.e., a second user interface) to an operator of the pooled vehicle for performing the one or more predetermined operations on the received travel request. In an embodiment, the operator may accept or decline the travel request by utilizing the GUI displayed on the vehicle-computing device 104. In an embodiment, the vehicle-computing device 104 may transmit the current location of the pooled vehicle, associated with the vehicle-computing device 104, to the application server 108, if the operator accepts the travel request. In an embodiment, the GPS sensor in the vehicle-computing device 104 may determine the current location of the pooled vehicle. In an embodiment, an exemplary GUI displayed on the vehicle-computing device 104 has been explained later in FIG. 8.

In an embodiment, the vehicle-computing device 104 may receive information pertaining to the pickup location of the commuter from the application server 108. Further, the vehicle-computing device 104 may receive information pertaining to the route associated with the travel request from the application server 108. In an embodiment, the pooled vehicle may already be travelling along the first route and a travel request may be received that may require a rerouting from the first route. In this scenario, the vehicle-computing device 104 may receive information pertaining to the route associated with the travel request. Further, the GPS sensor in the vehicle-computing device 104 may determine a detour distance and/or a detour time from the first route, caused by the travel request. The operator of the pooled vehicle may utilize the vehicle-computing device 104 to view the information pertaining to the pickup location of the commuter, and the information pertaining to the route associated with the travel request.

The vehicle-computing device 104 may correspond to a variety of computing devices, such as, but not limited to, a laptop, a PDA, a tablet computer, a smartphone, and a phablet.

In an embodiment, the database server 106 may refer to a computing device that may be communicatively coupled over the network 110. In an embodiment, the database server 106 may be configured to store a geographical map data of an area, the commuter profile, and traffic information at one or more time buckets in a day. In an embodiment, the geographical map data of the area may comprise one or more routes. In an embodiment, the traffic pattern at one or more time buckets in a day may correspond to a variable traffic pattern at the one or more time buckets in the day along the one or more routes. In an embodiment, the geographical map data may be stored as a weighted graph “G” in the database server 106, such that the weighted graph “G” may comprise one or more nodes. In an embodiment, the one or more nodes in the weighted graph “G” may represent one or more geographic regions. Further, the one or more nodes may be connected by one or more edges, such that an edge between any two nodes of the one or more nodes may represent a geographical distance between the geographic regions associated with the two nodes. In an embodiment, the weighted graph “G” may be represented by equation (1), as shown below:

G=(Z,E) (1)

where,

Z: represents the one or more nodes; and

E: represents the one or more edges connecting any two nodes among the one or more nodes.

In an embodiment, the database server 106 may be configured to store one or more constraints as specified by the service provider of the one or more pooled vehicles. The one or more constraints may comprise a second detour distance threshold, and/or a second waiting time threshold. In an embodiment, the application server 108 may query the database server 106 to extract information pertaining to the geographical map data of the area, the commuter profile, the traffic pattern, and/or the one or more constraints. For querying the database server 106, one or more querying languages may be utilized, such as, but not limited to, SQL, QUEL, DMX and so forth. Further, the database server 106 may be realized through various technologies, such as, but not limited to, Microsoft® SQL server, Oracle®, and My SQL®. In an embodiment, the database server 106 may connect to the application server 108, using one or more protocols, such as, but not limited to, ODBC protocol and JDBC protocol.

In an embodiment, the application server 108 refers to a computing device or a software framework hosting an application or a software service configured to determine a total cost incurred by the commuter (i.e., the first commuter and/or the second commuter) for travelling in the pooled vehicle. In an embodiment, the total cost incurred by the commuter may comprise a first cost and a second cost. Hereinafter, the total cost incurred by the commuter may be interchangeably used as a third cost.

In an embodiment, the application server 108 may include a special purpose operating system specifically configured to perform one or more operations to transmit information pertaining to the third cost, incurred by the commuter, to user-computing device 102 associated with the commuter (e.g., the first commuter and/or the second commuter) in real-time. The application server 108 may include one or more processors and one or more memories. The one or more memories may include computer readable code that may be executable by the one or more processors to perform one or more operations for transmitting the third cost in real-time. Examples of the one or more operations for transmitting information pertaining to the third cost may comprise, but are not limited to, receiving one or more travel requests from one or more commuters, determining one or more routes based on the one or more travel requests, identifying one pooled vehicle corresponding to each travel request from the one or more travel requests, and determining the first cost, the second cost and the third cost for the commuter travelling in the pooled vehicle.

In an embodiment, the application server 108 may be configured to receive the one or more travel requests from the one or more commuters. Thereafter, the application server 108 may query the database server 106 to extract the commuter profile of each commuter of the one or more commuters, information pertaining to the geographical map data, the traffic pattern, and/or the one or more constraints. In an embodiment, the application server 108 may identify the one or more routes based on the one or more travel requests and the geographical map data. In an embodiment, a route in the one or more routes may be associated with a travel request in the one or more travel requests. Thereafter, the application server 108 may determine the one or more pooled vehicles plying on the one or more routes. In an embodiment, the application server 108 may be configured to identify a pooled vehicle from the one or more pooled vehicles for at least one travel request in the one or more travel requests. Further, the identification of the pooled vehicle for a travel request may be based on the commuter profile of the commuter associated with the travel request and the one or more constraints. In an embodiment, the application server 108 may identify the pooled vehicle for more than one travel requests, based on the capacity of the pooled vehicle. For example, if the capacity of the pooled vehicle is four, maximum of four travel requests may be associated with the pooled vehicle. In an embodiment, the application server 108 may utilize one or more routing algorithms for the identification of the pooled vehicle for at least one travel request from the one or more travel requests. In an embodiment, the application server 108 may formulate an integer program for the identification of the pooled vehicle for each of the one or more travel requests. Further, the integer program may optimize a count of the one or more pooled vehicles identified for the one or more travel requests, a distance traveled by the one or more pooled vehicles and/or revenue generated by the one or more pooled vehicles.

In an embodiment, the application server 108 may transmit each of the one or more travel requests to the vehicle-computing device 104 associated with each of the identified one or more pooled vehicles. In an embodiment, the application server 108 may be configured to determine the first cost incurred by the second commuter, when the pooled vehicle detours from the first route to pick up the second commuter. In an embodiment, the first route may be associated with the travel request of the first commuter already travelling in the pooled vehicle. Further, the first cost may be compensated to the first commuter. In an embodiment, the application server 108 may determine the first cost based on the detour distance and/or the detour time information received from the vehicle-computing device 104 of the pooled vehicle. In another embodiment, application server 108 may be configured to determine the detour distance and/or the detour time associated with the travel request based on the geographical map data. In an embodiment, the application server 108 may utilize one or more tools, such as Open Trip Planner®, Google Maps®, and/or the like for the determination of the detour distance.

Further, the application server 108 may be configured to determine the second cost incurred by the first commuter and the second commuter. In an embodiment, the second cost for the first commuter may be determined based on a first distance and a second distance. In an embodiment, the first distance may be determined between a boarding location of the first commuter (i.e., a first node), and a boarding location of the second commuter (i.e., a second node). In an embodiment, the second distance may be determined between the boarding location of the second commuter (i.e., the second node) and a drop location of the first commuter (i.e., a third node). In an embodiment, the second cost for the second commuter may be determined based on the second distance determined between the boarding location of the second commuter (i.e., the second node) and a drop location of the second commuter (i.e., a fourth node). In an embodiment, the drop location of the first commuter (i.e., the third node) and the drop location of the second commuter (i.e., the fourth node) may be same.

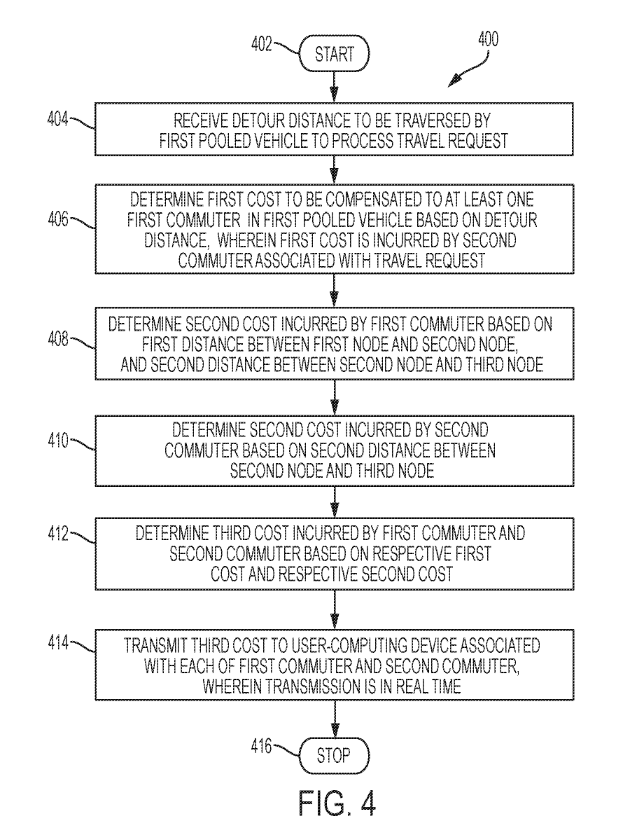

In an embodiment, the application server 108 may further determine the third cost for the first commuter and the second commuter based on the first cost and the corresponding second cost. In an embodiment, the application server 108 may be configured to transmit the information pertaining to the corresponding third cost to the commuter (e.g., the first commuter and/or the second commuter) in real-time. In an embodiment, the application server 108 may also transmit information pertaining to real-time saving associated with the commuter. A method of determining the first cost, the second cost, and the third cost has been described later in FIG. 4.

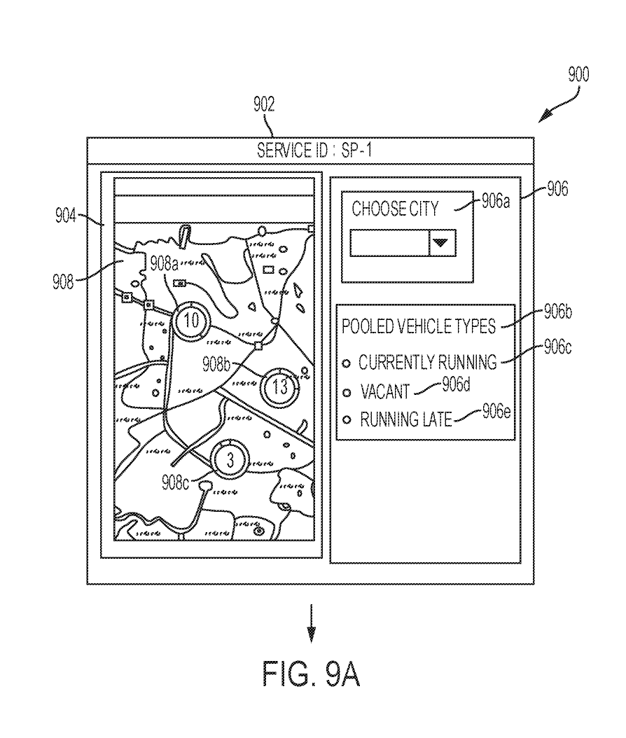

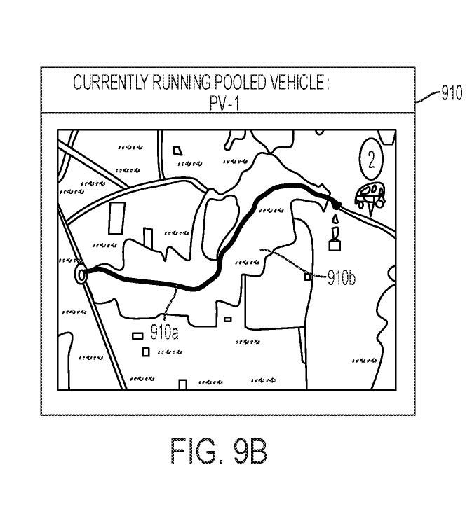

In an embodiment, the application server 108 may be configured to transmit a third user interface to an agent-computing device (not shown) associated with the service provider. The third user interface may comprise information pertaining to the one or more pooled vehicles associated with the service provider. The information may comprise a status and count of currently running pooled vehicles, a route associated with each of the one or more currently running pooled vehicles, and/or a permissible detour area associated with each of the currently running pooled vehicles. In an embodiment, an exemplary GUI presented on the agent-computing device of the service provider for displaying the third user interface has been described later in FIGS. 9A and 9B.

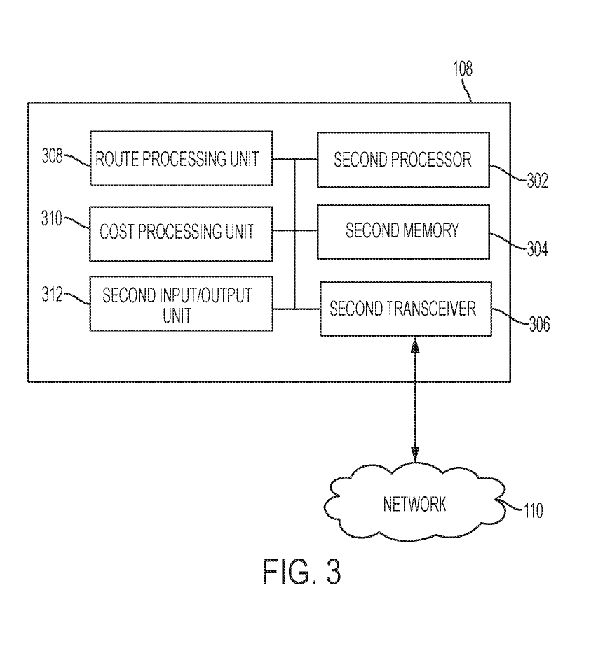

In an embodiment, the application server 108 may have communication capabilities that enable the application server 108 to transmit/receive data and messages, in accordance with one or more communication protocols, such as, but not limited to, FTP, WebDAV, E-Mail, SMB, NFS, and TWAIN. The application server 108 may be realized through various types of application servers, such as, but not limited to, a Java application server, a .NET framework application server, a Base4 application server, a PHP framework application server, or any other application server framework. In an embodiment, the structure of the application server 108 has been described later in FIG. 3.

A person having ordinary skill in the art will appreciate that the scope of the disclosure is not limited to realizing the database server 106 and the application server 108 as separate entities. In an embodiment, the functionalities of the database server 106 can be integrated into the application server 108.

A person having ordinary skill in the art will appreciate that the scope of the disclosure is not limited to realizing the application server 108 as a separate entity. In an alternate embodiment, the functionalities of the application server 108 may be performed by a dedicated application installed on the agent computing device (not shown) associated with the service provider of the pooled vehicle.

In an embodiment, the network 110 may correspond to a medium through which content and messages flow between various devices of the system environment 100 (e.g., the user-computing device 102, the vehicle-computing device 104, the database server 106, and the application server 108). Examples of the network 110 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 110, in accordance with the various wired and wireless communication protocols, such as Transmission Control Protocol and Internet Protocol (TCP/IP), User Datagram Protocol (UDP), and 2G, 3G, or 4G communication protocols.

FIG. 2 is a block diagram that illustrates the user-computing device 102, in accordance with at least one embodiment. FIG. 2 has been described in conjunction with FIG. 1. In an embodiment, the user-computing device 102 may include a first processor 202, a first memory 204, a first transceiver 206, a GPS unit 208, and a first input/output unit 210. The first processor 202 is communicatively coupled to the first memory 204, the first transceiver 206, the GPS unit 208, and the first input/output unit 210.

The first processor 202 includes suitable logic, circuitry, and/or interfaces that are configured to execute one or more instructions stored in the first memory 204 to perform the one or more operations as specified by the user on the user-computing device 102. The first processor 202 may be implemented using one or more processor technologies known in the art. Examples of the first processor 202 include, but are not limited to, an X86 processor, a Reduced Instruction Set Computing (RISC) processor, an Application-Specific Integrated Circuit (ASIC) processor, a Complex Instruction Set Computing (CISC) processor, or any other processor.

The first memory 204 stores one or more sets of instructions, codes, programs, algorithms, data, and/or the like. Some of the commonly known memory implementations include, but are not limited to, a random access memory (RAM), a read only memory (ROM), a hard disk drive (HDD), a solid-state drive (SSD), and a secure digital (SD) card. Further, the first memory 204 includes the one or more sets of instructions that are executable by the first processor 202 to perform the one or more operations as specified by the user on the user-computing device 102. It is apparent to a person having ordinary skills in the art that the one or more sets of instructions stored in the first memory 204 enable the hardware of the user-computing device 102 to perform the one or more user specified operations, without deviating from the scope of the disclosure.

The first transceiver 206 transmits/receives messages and data to/from various components of the system environment 100. In an embodiment, the first transceiver 206 may be communicatively coupled to the network 110. In an embodiment, the first transceiver 206 may be configured to store the current location of the commuter in the database server 106. In an alternate embodiment, the first transceiver 206 may be configured to transmit the current location of the commuter to the application server 108. Examples of the first transceiver 206 may include, but are not limited to, an antenna, an Ethernet port, a USB port, or any other port that can be configured to receive and transmit data. The first transceiver 206 transmits/receives messages and data, in accordance with various communication protocols, such as TCP/IP, UDP, and 2G, 3G, or 4G communication protocols.

The GPS unit 208 includes suitable logic, circuitry, and/or interfaces that are configured to determine a geographical location pertaining to the current location of the user-computing device 102, associated with the commuter. In an embodiment, the GPS unit 208 may be configured to track real-time locations of the commuter associated with the user-computing device 102. In an embodiment, the GPS unit 208 may be configured to store the current location of the user-computing device 102 in the first memory 204.

The first input/output unit 210 may comprise suitable logic, circuitry, interfaces, and/or code that may be configured to receive an input from the commuter. The first input/output unit 210 may be configured to communicate with the first processor 202. In an embodiment, the first input/output unit 210 may present the GUI to the commuter to submit an input for the travel request. In another embodiment, the first input/output unit 210 may display the first user interface to the commuter. In an embodiment, the first input/output unit 210 may display the first cost, the second cost and the third cost to the commuter, in real-time. Examples of the input devices may include, but are not limited to, a keyboard, a mouse, a joystick, a touch screen, a microphone, a camera, and/or a docking station. Examples of the output devices include, but are not limited to, a display screen and/or a speaker.

FIG. 3 is a block diagram that illustrates the application server 108, in accordance with at least one embodiment. FIG. 3 has been described in conjunction with FIG. 1. In an embodiment, the application server 108 includes a second processor 302, a second memory 304, a second transceiver 306, a route processing unit 308, a cost processing unit 310, and a second input/output unit 312. The second processor 302 is communicatively coupled to the second memory 304, the second transceiver 306, the route processing unit 308, the cost processing unit 310, and the second input/output unit 312.

The second processor 302 includes suitable logic, circuitry, and/or interfaces that are configured to execute one or more instructions stored in the second memory 304 to perform one or more cost determination operations. The second processor 302 may be implemented using one or more processor technologies known in the art. Examples of the second processor 302 may include, but are not limited to, an X86 processor, a RISC processor, an ASIC processor, a CISC processor, or any other processor.

The second memory 304 stores one or more sets of instructions, codes, programs, algorithms, data, and/or the like. Some of the commonly known memory implementations include, but are not limited to, a RAM, a ROM, a HDD, an SSD, and an SD card. Further, the second memory 304 includes the one or more sets of instructions that are executable by the second processor 302, the second transceiver 306, the route processing unit 308, the cost processing unit 310, and the second input/output unit 312. It is apparent to a person having ordinary skills in the art that the one or more sets of instructions stored in the second memory 304 enable the hardware of the application server 108 to perform the one or more cost determination operations, without deviating from the scope of the disclosure.

The second transceiver 306 transmits/receives messages and data to/from various components of the system environment 100. In an embodiment, the second transceiver 306 may be communicatively coupled to the network 110. Examples of the second transceiver 306 may include, but are not limited to, an antenna, an Ethernet port, an USB port, or any other port that can be configured to receive and transmit data. The second transceiver 306 transmits/receives messages and data, in accordance with the various communication protocols, such as TCP/IP, UDP, and 2G, 3G, or 4G communication protocols.

The route processing unit 308 may comprise suitable logic, circuitry, interfaces and/or code that may be configured to execute the one or more instructions stored in the second memory 304 to determine the one or more routes based on the one or more travel requests. In an embodiment, the route processing unit 308 may use one or more state of the art algorithms, such as Dijkstra's algorithm, Bellman-Ford algorithm, Floyd-Warshall algorithm, and the like to determine the one or more routes. The route processing unit 308 may be configured to identify the one or more pooled vehicles plying on the one or more routes. In an embodiment, the route processing unit 308 may be further configured to identify a pooled vehicle from the one or more pooled vehicles to address the one or more travel requests. In an embodiment, the route processing unit 308 may associate at least the pooled vehicle with a travel request in the one or more travel requests. The route processing unit 308 may utilize the commuter profile of the commuter associated with each of the one or more travel requests and the one or more constraints for the identification of the pooled vehicle for the one or more travel requests. In an embodiment, the route processing unit 308 may identify the pooled vehicle for more than one travel requests, based on the capacity of the pooled vehicle.

In an exemplary implementation, the route processing unit 308 may identify one or more source locations corresponding to one or more travel requests received from one or more commuters. Further, the route processing unit 308 may query the database server 106 to extract the geographical map data. Thereafter, the route processing unit 308 may generate a graph connecting the one or more source locations, based on the received geographical map data and the one or more source locations. In an embodiment, the graph may comprise the one or more routes associated with the one or more travel requests. The route processing unit 308 may utilize one or more known in the art methods, such as the Floyd-Warshall method, for the generation of the graph. The generated graph may be denoted by ( [symbol] , d), where [symbol] may represent the one or more source locations (i.e., the one or more nodes) and d may represent a weighted edge between any two source locations in [symbol] .

Based on the generated graph, the route processing unit 308 may formulate an integer program for the identification of a pooled vehicle for each of the one or more travel requests, based on the following equations:

$$\begin{matrix} minimize {\sum }_{e ∈ E}^{ } {\sum }_{j ∈ \{ 1 , … , m \}}^{ } {\sum }_{k = 1}^{C} {y}_{e , j , k} {d}_{e} + {m}^{′} & ( 2 ) \\ such that , {x}_{i , j , k} \leq {\sum }_{e = ( i , *)}^{ } {y}_{e , j , k} ∀ i ∈ \backslash D , j ∈ \{ 1 , … , m \} , \\ k ∈ \{ 1 , … , C \} & ( 3 ) \\ {\sum }_{j ∈ \{ 1 , … , m \}}^{ } {\sum }_{e ∈ E}^{ } {y}_{e , j , 1} \leq {m}^{′} & ( 4 ) \\ {\sum }_{j ∈ \{ 1 , … , m \}}^{ } {\sum }_{k ∈ \{ 1 , … , C \}}^{ } {x}_{i , j , k} = 1 ∀ i ∈ \backslash D & ( 5 ) \\ {\sum }_{j ∈ \{ 1 , … , m \}}^{ } {\sum }_{k = 1}^{C} {y}_{e , j , k} \leq ∀ e ∈ E & ( 6 ) \\ {\sum }_{e ∈ E}^{ } {y}_{e , j , k} \leq 1 ∀ j ∈ \{ 1 , … , m \} , k ∈ \{ 1 , … , C \} & ( 7 ) \\ {\sum }_{e = (* , u )}^{ } {y}_{e , j , k} \geq {\sum }_{{e}^{′} = (* , u )}^{ } {y}_{{e}^{′} , j , k + 1} ∀ j ∈ \{ 1 , … , m \} , \\ ∀ u ∈ \{ 1 , … , n \} , ∀ k ∈ \{ 1 , … , C - 1 \} & ( 8 ) \\ {\sum }_{j ∈ \{ 1 , … , m \}}^{ } {\sum }_{k = 1}^{C} {\sum }_{e = (* , u )}^{ } {y}_{e , j , k} = 1 ∀ u ∈ \backslash d & ( 9 ) \\ {\sum }_{j ∈ \{ 1 , … , m \}}^{ } {\sum }_{k = 1}^{C - 1} {\sum }_{e = (* , u )}^{ } {y}_{e , j , k} \leq 1 ∀ u ∈ \backslash d & ( 10 ) \\ {\sum }_{u ∈}^{ } {x}_{u , j , k - 1} ( {d}_{u , i} - {d}_{u , D} ) + {x}_{i , j , k} {d}_{i , D} \leq \frac{1}{k} {x}_{i , j , k} {d}_{i , D} ∀ k ∈ \{ 1 , … , C \} , \\ ∀ j ∈ \{ 1 , … , m \} , ∀ i ∈ \backslash D & ( 11 ) \\ {\sum }_{j ∈ \{ 1 , … , m \}}^{ } {\sum }_{e = (* , D )}^{ } {\sum }_{k ∈ \{ 1 , … , C \}}^{ } {y}_{e , j , k} = {m}^{′} & ( 12 ) \\ {\sum }_{j ∈ \{ 1 , … , m \}}^{ } {\sum }_{e = ( D , * )}^{ } {y}_{e , j , k} = 0 & ( 13 ) \\ {y}_{e , j , k} ∈ \{ 0 , 1 \} ∀ e ∈ E , j ∈ \{ 1 , … , m \} , k ∈ \{ 1 , … , C \} & ( 14 ) \\ {x}_{i , j , k} ∈ \{ 0 , 1 \} ∀ i ∈ \backslash D , j ∈ \{ 1 , … , m \} , k ∈ \{ 1 , … , C \} & ( 15 )\end{matrix}$$

where,

[symbol] : represents one or more source locations corresponding to each of the one or more travel requests;

n: represents a count of the one or more travel requests;

m: represents a count of the one or more pooled vehicles;

m′: represents a count of pooled vehicles in a set of pooled vehicles from the one or more pooled vehicles, such that m′ pooled vehicles may be utilized to address the one or more travel requests;

e: represents an edge associated with a part of a route in the one or more routes, where eεE;

dₑ: represents a weight assigned to an edge e, such that edge e connect two nodes (i.e., p and q), where p, qε [symbol] ;

C: represents the capacity of each of the one or more pooled vehicles;

y_{e,j,k}: indicates an edge e, such that the edge e is the k^{th} edge in a route of a j^{th} pooled vehicle, where the route may comprise one or more nodes connected by one or more edges;

x_{i,j,k}: indicates a node “i”, such that the node “i” is a “k^{th}” pickup for the “j^{th}” pooled vehicle; and

D: represents a destination location associated with each of the one or more travel requests, such that the one or more travel requests may have a same destination location.

As shown above, the integer program problem is represented in equation (2), while equations (3)-(15) may represent one or more routing constraints (specified by the service provider). In an embodiment, the route processing unit 308 may be configured to determine the one or more routing constraints, in conjunction with the cost processing unit 310.

In an embodiment, the aim of the integer problem (equation (2)) is to minimize the count of one or more pooled vehicles identified for the one or more travel requests and to minimize the distance traveled by the one or more pooled vehicles. Equation (3) represents a constraint such that a source location “i” may correspond to a “k^{th}” pick up of a pooled vehicle in a “j^{th}” route in the one or more routes, only if an outgoing edge incident on the source location “i” is at the “k^{th}” position. Equation (4) may represent a constraint on the maximum count of the one or more pooled vehicles. Equation (5) may represent a constraint such that each of the one or more source locations may be associated with at least one pooled vehicle. Equation (6) and equation (7) may represent constraints such that an edge may be associated with only one route in the one or more routes and only one edge may be associated with a pooled vehicle at a given time (i.e., based on the current location of the pooled vehicle).

Further, equation (8) may represent a constraint such that a first edge leading to a source location “u” may be chosen as a “k^{th}” edge in a route traveled by a pooled vehicle, only if there exists a second edge, leading out of the source location “u,” at a “k+1^{th}” position in the route. Equation (9) and equation (10) may represent a constraint that a source location may only be associated with the pooled vehicle, such that there may be only one travel request corresponding to one source location. Equation (11) may represent a constraint that a source location “i” may be considered as a “k^{th}” pick up location for the pooled vehicle, when

$$( 1 - \frac{1}{k} )$$

times a distance d(i, D) exceeds a difference between a distance d(u, D) and a distance d(u, i). In this scenario, “u” may be a “k−1^{th}” pick up of the pooled vehicle and d(a, b) may represent a distance between “a” and “b.”

Further, equation (12) may represent a constraint such that a count of one or more edges leading into the destination location “D” may be equal to the count of pooled vehicles in the set of pooled vehicles. Equation (13) may represent a constraint, such that the destination location may correspond to a last node in each of the one or more routes. Equation (14) and equation (15) may represent that y_{e,j,k} and x_{i,j,k} corresponds to binary values (i.e., 0 or 1).

A person having ordinary skill in the art may appreciate that the above mentioned exemplary implementation is for illustrative purpose and should not be construed to limit the scope of the disclosure. Further, in an embodiment, the one or more travel request may correspond to different destination locations.

In another embodiment, the route processing unit 308 may identify the pooled vehicle for a travel request. In an embodiment, the pooled vehicle may have a vacancy and already be travelling on a first route, such that the first commuter may be travelling in the pooled vehicle on the first route. In an embodiment, the route processing unit 308 may identify the pooled vehicle such that the third cost of the first commuter must not exceed the estimated cost due to the processing of the travel request by the pooled vehicle. In an embodiment, the route processing unit 308 may utilize the one or more routing constraints in conjunction with the cost processing unit 310, such that the third cost for each of the customer (i.e., the first commuter and the second commuter) may be less than or equal to the estimated cost. For the identification of the pooled vehicle for the travel request the application server 108 may be configured to determine a bipartite graph between the source location associated with the travel request and the first route associated with the one or more pooled vehicles. The route processing unit 308 may associate the travel request with the pooled vehicle from the one or more pooled vehicle, such that the processing of travel request adds a minimum overhead to the pooled vehicle. In another embodiment, the route processing unit 308 may identify an empty pooled vehicle for the travel request when the one or more pooled vehicles already plying on the first route have no vacancy.

In an embodiment, the route processing unit 308 may be implemented using one or more processor technologies known in the art. Examples of the route processing unit 308 may include, but are not limited to, an X86, a RISC processor, a CISC processor, or other such processor. In another embodiment, the route processing unit 308 may be implemented as an ASIC microchip designed for a special application, such as determining the one or more routes and identifying the set of pooled vehicles for the one or more travel requests.

The cost processing unit 310 may comprise suitable logic, circuitry, interfaces and/or code that may be configured to execute the one or more instructions stored in the second memory 304 to determine the first cost, the second cost and the third cost for the commuter. In an embodiment, the cost processing unit 310 may further determine the estimated cost associated with each of the one or more travel requests, based on each of a distance of the route associated with the travel request and a count of commuters in the pooled vehicle associated with the travel request. The cost processing unit 310 may determine the third cost such that the third cost is less than or equal to the estimated cost. In an embodiment, the cost processing unit 310 may further determine the real-time saving associated with the commuter. The real-time saving may correspond to a difference between the estimated cost and the third cost. Further, the cost processing unit 310 may work in conjunction with the route processing unit 308. In an embodiment, the cost processing unit 310 may be implemented using one or more processor technologies known in the art. Examples of the cost processing unit 310 may include, but are not limited to, an X86, a RISC processor, a CISC processor, or any other processor. In another embodiment, the cost processing unit 310 may be implemented as an ASIC microchip designed for a special application, such as determining the first cost, the second cost, and the third cost.

The second input/output unit 312 may comprise suitable logic, circuitry, interfaces, and/or code that may be configured to receive the request or provide an output to the commuter. The second input/output unit 312 comprises various input and output devices that are configured to communicate with the second processor 302. Examples of the input devices may include, but are not limited to, a keyboard, a mouse, a joystick, a touch screen, a microphone, a camera, and/or a docking station. Examples of the output devices may include, but are not limited to, a display screen and/or a speaker. In an embodiment, the operation of the application server 108 has been described later in FIG. 4.

FIG. 4 is a flowchart that illustrates a method for cost sharing in an exemplary pooled vehicle, in accordance with at least one embodiment. FIG. 4 has been described in conjunction with FIGS. 1-3. With reference to FIG. 4, there is shown a flowchart 400 that illustrates a method for cost sharing in a pooled vehicle of one or more pooled vehicles. For the purpose of ongoing description, the method has been explained for one first commuter travelling on a first route in the pooled vehicle. The method starts at step 402 and proceeds to step 404.

At step 404, the detour distance to be traversed by the pooled vehicle is received to process the travel request (received at the vehicle-computing device 104 in the pooled vehicle). In an embodiment, the second transceiver 306, in conjunction with the second processor 302 may be configured to receive the detour distance to be traversed by the pooled vehicle to process the travel request received at the vehicle-computing device 104 of the pooled vehicle.

Prior to the reception of the detour distance, the second transceiver 306 may be configured to transmit the travel request to the vehicle-computing device 104 in the pooled vehicle. For the transmission of the travel request, the route processing unit 308 may be configured to identify the pooled vehicle from the one or more pooled vehicles. In an embodiment, the route processing unit 308 may identify the pooled vehicle from the one or more pooled vehicles, based on the commuter profile of the first commuter, the commuter profile of the second commuter associated with the travel request and the one or more constraints specified by the service provider of the pooled vehicle. In an embodiment, the first commuter may correspond to the commuter who is already travelling in the pooled vehicle along the first route. In an embodiment, the second processor 302 may be configured to transmit a query to the database server 106, through the second transceiver 306 over the network 110, for extracting the commuter profile of the first commuter, the commuter profile of the second commuter, the one or more constraints, and the geographical map data. Further, the route processing unit 308 may query the database server 106 to extract the current location of the one or more pooled vehicles.

In an embodiment, the route processing unit 308 may be configured to determine a second route associated with the travel request. Thereafter, the route processing unit 308 may be configured to identify the set of pooled vehicles from the one or more pooled vehicles, such that the source location, associated with the travel request, is within the permissible detour area associated with the current location of each pooled vehicle in the set of pooled vehicles. In an embodiment, the route processing unit 308 may fail to identify the set of pooled vehicles from the one or more pooled vehicles when the source location associated with the travel request is outside the permissible detour area associated with the current location of each of the one or more pooled vehicles.

In an embodiment, the route processing unit 308 in conjunction with the cost processing unit 310 may be configured to determine the permissible detour area. In an embodiment, the permissible detour area, for a pooled vehicle in the set of pooled vehicles, may encompass one or more locations, such that the pooled vehicle travelling along a first route is permitted to detour from the first route to process the travel request that originated at a location of the one or more locations. In an embodiment, the permissible detour area may be determined based on a predefined criteria. In an embodiment, the predefined criteria may be defined by the service provider of the pooled vehicle. For example, for a location “I,” if “n” times a distance d(i, D), is less than or equal to a difference between a distance d(u, D) and a distance d(u, i), “i” may be considered a location within the permissible detour area. Here, “i” may represent a location within the permissible detour area, “u” may represent the current location of a pooled vehicle in the set of pooled vehicles, “D” may represent a destination location of the pooled vehicle and “n” may be specified by the service provider of the pooled vehicle. In an embodiment, the service provider of the pooled vehicle may define “n” as

$$“ 1 - \frac{1}{k} ”$$

such that the location “i” may represent a “k^{th}” pickup of the pooled vehicle and the location “u” (i.e., the current location) may represent a “k−1^{th}” pickup of the pooled vehicle. In an embodiment, the permissible detour area may decrease as distance between the current location of the pooled vehicle and the destination location of the first route decreases. For example, a pooled vehicle in the set of pooled vehicles may be travelling between a first location “A” and a second location “B” along a first route (e.g., “A->a->b->B”) of “4 miles,” where “a” and “b” may be intermediate nodes on the first route. The permissible detour area, when the current location of the pooled vehicle is “a” may be larger than the permissible detour area, when the current location of the pooled vehicle is “b.” Thus, the permissible detour area may decrease as the pooled vehicle further progresses along the first route (i.e., towards “B”). Thereafter, the route processing unit 308 may be configured to identify the pooled vehicle from the set of pooled vehicles, based on the extracted commuter profile of each of the first commuter and the second commuter, and the one or more constraints.

In an exemplary implementation, with reference to Table 1, “Commuter-1” may correspond to the first commuter in a pooled vehicle (e.g., PV-1) in the set of pooled vehicles, and “Commuter-2” may correspond to the second commuter associated with the travel request. Further, the pooled vehicle (i.e., PV-1) and another pooled vehicle (i.e., PV-2) may be progressing along a first route (e.g., “A->a->b->c->B”), the current location of the pooled vehicles (i.e., PV-1 and PV-2) may be “a” and a radius of the permissible detour area for “a” may be within “0.9 miles.” Thereafter, the route processing unit 308 may determine that the commuter profile of the second commuter “Commuter-2” and the commuter profile of the first commuter in the pooled vehicle (i.e., PV-1) are compatible (referring to Table 1). In an embodiment, the route processing unit 308 may identify the pooled vehicle (i.e., PV-1) for a travel request from a commuter, who is female, as based on the commuter profile of the first commuter the pooled vehicle (i.e., PV-1) who may only be identified for a travel request from a female commuter. Thereafter, the route processing unit 308 may check if all of the one or more constrains are met. In such a case, the route processing unit 308 may identify the pooled vehicle (i.e., PV-1) for the travel request from the second commuter (i.e., “Commuter-2”).

After, the identification of the pooled vehicle (i.e., PV-1) for the travel request, the second transceiver 306 may be configured to transmit the travel request to the vehicle-computing device 104 associated with the identified pooled vehicle (i.e., PV-1). Thereafter, based on the received travel request, the GPS sensor in the vehicle-computing device 104 of the pooled vehicle (i.e., PV-1) may be configured to determine the detour distance, from the first route, caused by the travel request. The GPS sensor in the vehicle-computing device 104 may determine the extra distance from the first route that the first commuter in the pooled vehicle (i.e., PV-1) may have to travel due to the second request. For example, a pooled vehicle (i.e., PV-1) may be traversing along a first route (i.e., “A->a->b->c->B”) of “4 miles.” Further, based on a received travel request the pooled vehicle (i.e., PV-1) may have to start a detour from “a” and travel along a second route (i.e., “A->a->d->e->B”) of “4.8 miles.” In this scenario, the GPS sensor may determine the extra “0.8 miles” traveled by the first commuter in the pooled vehicle (i.e., PV-1) as the detour distance. Thereafter, the second transceiver 306 may receive the detour distance, determined by the GPS sensor, from the vehicle-computing device 104.

In another embodiment, the GPS sensor in the vehicle-computing device 104 of the pooled vehicle (i.e., PV-1) may be configured to determine the detour time, from the estimated time associated with the first route, caused by the travel request. The GPS sensor in the vehicle-computing device 104 may determine the extra time from the estimated time associated with the first route that the first commuter in the pooled vehicle (i.e., PV-1) may have to spend in travelling in the pooled vehicle due to the second request. For example, the pooled vehicle (i.e., PV-1) may be traversing along a first route (i.e., “A->a->b->c->B”) with an estimated time of “1 hour.” Further, based on a received travel request the pooled vehicle (i.e., PV-1) may have to start a detour from “a” and travel along a second route (i.e., “A->a->d->e->B”) with an estimated time of “1 hour 20 minutes.” In this scenario, the GPS sensor may determine the extra “20 minutes” spent by the first commuter in travelling in the pooled vehicle (i.e., PV-1) as the detour time.

In an alternate embodiment, the route processing unit 308 may be configured to determine the detour distance and/or the detour time associated with the travel request prior to the transmission of the travel request to the pooled vehicle (i.e., PV-1) based on the geographical map data. In an embodiment, the route processing unit 308 may utilize the one or more tools known in the art, such as Open Trip Planner®, Google Maps®, and/or the like for determining the detour distance.

At step 406, the first cost to be compensated to the at least one first commuter “Commuter-1” in the pooled vehicle (i.e., a first pooled vehicle PV-1) is determined based on the detour distance, wherein the first cost is incurred by the second commuter “Commuter-2” associated with the travel request. In an embodiment, the cost processing unit 310 in conjunction with the second processor 302 may be configured to determine the first cost to be compensated to the at least one first commuter “Commuter-1” in the pooled vehicle (i.e., PV-1) based on the detour distance, wherein the first cost is incurred by the second commuter “Commuter-2” associated with the travel request. In another embodiment, the cost processing unit 310 may utilize the detour time for determining the first cost.

To determine the first cost to be compensated to the at least one first commuter “Commuter-1” in the pooled vehicle (i.e., PV-1), the cost processing unit 310 utilize the base fare as specified by the service provider of the pooled vehicle (i.e., PV-1) and the detour distance received from the vehicle-computing device 106. To determine the first cost, the cost processing unit 310 may utilize equation (16), as shown below:

first cost=base fare*detour distance (16)

where,

base fare: represents a fixed price rate (e.g., “USD 8 per mile”) specified by the service provider of the pooled vehicle (i.e., PV-1).

In an alternate embodiment, the cost processing unit 310 may utilize the detour time to determine the first cost. To determine the first cost, the cost processing unit 310 may utilize equation (17), as shown below:

first cost=base fare*(Δt_{A(t)a(t)}+Δt_{a(t)B(t)}−Δt_{A(t)B(t)} (17)

where,

base fare: represents a fixed price rate (e.g., “USD 8 per hour”) specified by the service provider of the pooled vehicle (i.e., PV-1);

A(t): represents a time instance of pickup of the first commuter “Commuter-1” from the source location (e.g., “A”);

a(t): represents a time instance at which the pooled vehicle (i.e., PV-1) detours from node “a” in the first route to process the travel request;

B(t): represents a time instance at which the pooled vehicle (i.e., PV-1) drops the first commuter “Commuter-1” and the second commuter “Commuter-2” at the destination location (i.e., “B”);

Δt_{A(t)a(t)}: represents a time duration between the time instance of pickup of the first commuter “Commuter-1” and the time instance at which the pooled vehicle (i.e., PV-1) detours from node “a” in the first route to process the travel request;

Δt_{a(t)B(t)}: represents a time duration between the time instance at which the pooled vehicle (i.e., PV-1) detours from node “a” in the first route to process the travel request and the time instance at which the pooled vehicle (i.e., PV-1) drops the first commuter “Commuter-1” and the second commuter “Commuter-2” at the destination location;

Δt_{A(t)B(t)}: represents an estimated time to travel from the source location “A” to the destination location “B” for the first commuter “Commuter-1”; and

(t_{A(t)a(t)}+Δt_{a(t)B(t)}−Δt_{A(t)B(t)}): represents the detour time caused due to the processing of the travel request of the second commuter “Commuter-2”.

In an alternate embodiment, the cost processing unit 310 may utilize the cost per unit time parameter in the commuter profile of the first commuter “Commuter-1” to determine the first cost. To determine the first cost, the cost processing unit 310 may utilize equation (18), as shown below:

first cost=Cⱼ(Δt_{A(t)a(t)}+Δt_{a(t)B(t)}−Δt_{A(t)B(t)}) (18)

where,

Cⱼ: represents the cost per unit time parameter in the commuter profile of the first commuter “Commuter-1.”

In an embodiment, the second transceiver 306 may be configured to transmit information pertaining to the first cost to the user-computing device 102 associated with the first commuter “Commuter-1” and the user-computing device 102 associated with the second commuter “Commuter-2.” In an embodiment, the second transceiver 306 may transmit the information pertaining to the first cost in real-time. In an embodiment, the second transceiver 306 may transmit the information pertaining to the first cost, during a time duration between a time instance at which the pooled vehicle (i.e., PV-1) detours from a node in the first route to process the travel request and a time instance at which the second commuter “Commuter-2” may board the pooled vehicle (i.e., PV-1). In another embodiment, the second transceiver 306 may transmit the information pertaining to the first cost after the pooled vehicle (i.e., PV-1) may have picked up the second commuter “Commuter-2,” when the first cost may be determined based on the detour time.

For example, the cost processing unit 310 may determine a first cost as “USD 3.” Further, the distance (e.g., D_{aC}) between the location at which the pooled vehicle (i.e., PV-1) detours to process the travel request (e.g., “a”) and the boarding location of the second commuter “Commuter-2” (e.g., “C”) may be, determined by the GPS sensor in the pooled vehicle (i.e., PV-1) as “3 miles.” In this scenario, the second transceiver 306 may transmit the information pertaining to the first cost to the user-computing device 102 associated with the first commuter “Commuter-1” and the second commuter “Commuter-2” as “USD 1 per mile” (i.e., USD 3/3 miles=USD 1 per mile). In an embodiment, the first commuter “Commuter-1” may be compensated by the second commuter “Commuter-2.”

At step 408, the second cost incurred by the first commuter “Commuter-1” is determined based on the first distance between the first node, and the second node and the second distance between the second node and the third node. In an embodiment, the cost processing unit 310 in conjunction with the second processor 302 may determine the second cost incurred by the first commuter “Commuter-1” based on the first distance between the first node, and the second node and the second distance between the second node and the third node. In an embodiment, the first node may correspond to the boarding location of the first commuter “Commuter-2.” Further, the second node may correspond to the boarding location of the second commuter “Commuter-2.” Furthermore, the third node may correspond to the drop location of the first commuter “Commuter-1.”

For example, a first commuter “Commuter-1” may board the pooled vehicle (i.e., PV-1) from a first node (e.g., “A”) to travel along a first route. The pooled vehicle (i.e., PV-1) may detour from the first route to process a travel request of a second commuter “Commuter-2.” Further, the second commuter “Commuter-2” may board the pooled vehicle (i.e., PV-1) at a second node (e.g., “B”). The first commuter and the second commuter “Commuter-2” may have a same drop location, i.e., the third node (e.g., “C”). In this scenario, the second cost for the first commuter “Commuter-1” may be determined for a first distance between the first node “A,” and the second node “B” and a second distance between the second node “B” and, the third node “C.”

In an embodiment, the cost processing unit 310 may further determine the second cost incurred by the first commuter “Commuter-1” based on a count of commuters in the pooled vehicle (i.e., PV-1) during the travel associated with each of the first distance and the second distance. For example, for a first distance (e.g., “2 miles”) there may be one commuter (e.g., “Commuter-1”) travelling in the pooled vehicle (i.e., PV-1) and for a second distance (e.g., “3 miles”) there may be two commuters (e.g., “Commuter-1” and “Commuter-2”) in the pooled vehicle (i.e., PV-1). A base fare associated with the pooled vehicle (i.e., PV-1) may be “USD 2 per mile”. In this scenario, a second cost associated with “Commuter-1” may be determined as “USD 7,” i.e., “USD 4” (i.e., 2 miles*USD per mile) for the first distance and “USD 3”

$$( i . e . , 3 miles * ( \frac{USD per mile}{2} ) )$$

for the second distance.

In an embodiment, the second transceiver 306 may be configured to transmit information pertaining to the second cost incurred by the first commuter “Commuter-1” to the user-computing device 102 associated with the first commuter “Commuter-1.” In an embodiment, the transmission of the information pertaining to the second cost may be in real-time. For example, the cost processing unit 310 may determine a second cost (e.g., “USD 7”) for the first commuter “Commuter-1,” i.e., “USD 4” for a first distance of “2 miles” and “USD 3” for a second distance of “3 miles.” In this scenario, the user-computing device 102 associated with the first commuter “Commuter-1” may display an increment of “USD 2 per miles,” for the first distance and an increment of “USD 1 per mile” for the second distance in the real-time cost displayed to the first commuter “Commuter-1.”

At step 410, the second cost incurred by the second commuter “Commuter-2” is determined based on the second distance between the second node, and the third node. In an embodiment, the cost processing unit 310 in conjunction with the second processor 302 may be configured to determine the second cost incurred by the second commuter “Commuter-2” based on the second distance between the second node and the third node.

For example, the first commuter “Commuter-1” may board the pooled vehicle (i.e., PV-1) from a first node (e.g., “A”) to travel along a first route. The pooled vehicle (i.e., PV-1) may detour from the first route to process a travel request of the second commuter “Commuter-2.” Further, the second commuter “Commuter-2” may board the pooled vehicle (i.e., PV-1) at a second node (e.g., “B”). The first commuter “Commuter-1” and the second commuter “Commuter-2” may have a same drop location, i.e., the third node (e.g., “C”). In this scenario, the second cost for the second commuter “Commuter-2” may be determined for a second distance between the second node “B,” and the third node “C.”

In an embodiment, the cost processing unit 310 may further determine the second cost incurred by the second commuter “Commuter-2” based on a count of commuters in the pooled vehicle (i.e., PV-1) during the travel associated with the second distance. For example, for a first distance (e.g., “2 miles”) there may be one first commuter “Commuter-1” travelling in the pooled vehicle (i.e., PV-1) and for a second distance (e.g., “3 miles”) there may be one first commuter (e.g., “Commuter-1”) and one second commuter “Commuter-2” in the pooled vehicle (i.e., PV-1). A base fare associated with the pooled vehicle (i.e., PV-1) may be “USD 2 per mile.” In this scenario, a second cost associated with “Commuter-2” may be determined as “USD 3”

$$( i . e . , 3 miles * ( \frac{USD per mile}{2} ) )$$

for the second distance.

A person having ordinary skill in the art will understand that the abovementioned example is for illustrative purpose and should not be construed to limit the scope of the disclosure. Further, the scope of the disclosure is not limited to one first commuter. In an embodiment, there may be a plurality of first commuters in the pooled vehicle.

At step 412, the third cost incurred by the first commuter “Commuter-1” and the second commuter “Commuter-2” is determined based on the respective first cost and the respective second cost. In an embodiment, the cost processing unit 310 in conjunction with the second processor 302 may be configured to determine the third cost incurred by the first commuter “Commuter-1” and the second commuter “Commuter-2,” based on the respective first cost and the second cost. In an embodiment, the third cost may comprise the first cost and the second cost. Further, the third cost for each of the first customer and the second customer may be less than or equal to the corresponding estimated cost. In an embodiment, cost processing unit 310 may determine the third cost for each of the first customer and the second customer, such that the third cost is less than or equal to the estimated cost.

For the first commuter “Commuter-1,” the cost processing unit 310 may determine the third cost based on a subtraction between the corresponding second cost and the first cost. For example, the cost processing unit 310 may determine a first cost (e.g., “USD 2”) to be compensated to the first commuter “Commuter-1” for the detour distance caused by a travel request. Further, the cost processing unit 310 may determine a second cost (e.g., “USD 5”) for a first distance and a second distance traveled by the first commuter “Commuter-1” in the pooled vehicle (i.e., PV-1). Thus, the third cost determined by the cost processing unit 310 may be “USD 3” (i.e., USD 5−USD 2=USD 3).

For the second commuter “Commuter-2,” the cost processing unit 310 may determine the third cost based on an addition between the corresponding second cost and the first cost. For example, the cost processing unit 310 may determine a first cost (e.g., “USD 2”) to be incurred by the second commuter “Commuter-2” for the detour distance caused by a travel request of the second commuter “Commuter-2.” Further, the cost processing unit 310 may determine a second cost (e.g., “USD 2”) for a second distance traveled by the second commuter “Commuter-2” in the pooled vehicle (i.e., PV-1). Thus, the third cost determined by the cost processing unit 310 may be “USD 4” (i.e., USD 2+USD 2=USD 4).

A person having ordinary skill in the art will understand that the abovementioned examples are for illustrative purposes and should not be construed to limit the scope of the disclosure.

At step 414, the third cost is transmitted to the user-computing device 102 associated with each of the first commuter “Commuter-1” and the second commuter “Commuter-2,” wherein the transmission is in real-time. In an embodiment, the second transceiver 306 in conjunction with the second processor 302 may be configured to transmit the third cost to the user-computing device 102 associated with each of the first commuter “Commuter-1” and the second commuter “Commuter-2.” The third cost comprises the first cost and the second cost. In an embodiment, a real-time update of the third cost is rendered on a graphical user interface of the user-computing device 102. In an embodiment, the real-time transmission may correspond to an update of the real-time cost displayed on the first input/output unit 210 of the user-computing device 102 after a predefined time interval. For example, the third cost may be transmitted on the user-computing device 102 associated with a first commuter “Commuter-1” in real-time, such that the real-time cost displayed on the first input/output unit 210 of the user-computing device 102 may be updated after every “15 seconds.” In another embodiment, the real-time transmission may correspond to an update of the real-time cost displayed on the first input/output unit 210 of the user-computing device 102 after the pooled vehicle (i.e., PV-1) has traversed a predefined distance. For example, the third cost may be transmitted on the user-computing device 102 associated with a first commuter “Commuter-1” in real-time, such that the cost displayed on the first input/output unit 210 of the user-computing device 102 may be updated after every “500 meters” of travel by the pooled vehicle (i.e., PV-1). In an embodiment, the real-time update of the third cost is rendered on the graphical user interface of the user-computing device 102.

For the first commuter “Commuter-1,” the real-time transmission of the third cost associated with a distance (i.e., a first part of the first distance) between the boarding location of the first commuter “Commuter-1” and the location from where the pooled vehicle (i.e., PV-1) may detour to process the travel request (i.e., a detour location), may correspond to a first part of the second cost (i.e., C₁^{second}). In an embodiment, the first part of the second cost may be determined for the first part of the first distance.

For example, the cost processing unit 310 may determine a second cost associated with the first distance of “4 miles” as “USD 8.” Further, the distance between the boarding location of the first commuter “Commuter-1” and detour location may be determined as “1 mile.” Thus, the cost processing unit 310 may determine the first part of the second cost as “C₁^{second}”

$$( i . e . , {C}_{1}^{second} \text{=} \text{>} ( \frac{1}{4} ) * USD 8 = USD 2 ) .$$

Thus, the second transceiver 306 may transmit information associated with the first part of the second cost C₁^{second} (i.e., C₁^{second}=USD 2) to the user-computing device 102 associated with first commuter “Commuter-1.”

Further, the real-time transmission of the third cost to the first commuter “Commuter-1,” associated with a distance (i.e., a second part of the first distance) between the detour location and the boarding location of the second commuter “Commuter-2,” may correspond to a second part of the second cost (i.e., C₂^{second}) and the first cost (i.e., C^{first}). In an embodiment, the second part of the second cost (i.e., C₂^{second}) may be determined for the second part of the first distance. For example, the cost processing unit 310 may determine a second cost associated with the first distance of “4 miles” as “USD 8.” The cost processing unit 310 may determine a first cost as “USD 2.” Further, the distance between the detour location and a boarding location of the second commuter “Commuter-2,” may be determined as “3 miles” (i.e., Dₐ). The cost processing unit 310 may determine the second part of the second cost as “C₂^{second}”

$$( i . e . , {C}_{2}^{second} \text{=} \text{>} ( \frac{3}{4} ) * USD 8 = USD 6 ) .$$

Thereafter, the second transceiver 306 may transmit information associated with the second part of the second cost (i.e., C₂^{second}) and the first cost (i.e., “−USD 2”) to the user-computing device 102 associated with the first commuter “Commuter-1,” when the pooled vehicle (i.e., PV-1) may be travelling between the detour location and the boarding location of the second commuter “Commuter-2.” In an embodiment, the information pertaining to the third cost transmitted, to the first commuter “Commuter-1” on the user-computing device 102, between the detour location and the boarding location of the second commuter “Commuter-2” may comprise a subtraction of the first cost from the second part of the second cost. For example, an update of the real-time cost (i.e., C_{final}) on the user-computing device 102 of the first commuter “Commuter-1” may be determined as cost difference shown by equation (19), as shown below,

C_{final}=(C₂^{second}−C_{first})/Dₐ (19)

where,

C₂^{second}: represents a second part of a second cost (e.g., “USD 6”) determined for a second part of first distance traveled by the first commuter “Commuter-1”;

C^{first}: represents a first cost (e.g., “USD 2”) to be compensated to the first commuter “Commuter-1”;

Dₐ: represents the second part of the first distance (e.g., “3 miles”), i.e., between the detour location and the boarding location of the second commuter “Commuter-2”; and

C_{final}: represents the information pertaining to the third cost (e.g., “USD 1.33 per mile”), transmitted during the travel between the detour location and the boarding location of the second commuter “Commuter-2.”

Furthermore, the real-time transmission of the third cost, to the first commuter “Commuter-1,” associated with a distance between the boarding location of the second commuter “Commuter-2” and the drop location of the first commuter “Commuter-1” or the second commuter “Commuter-2,” may correspond to the second cost determined for the second distance. For example, the cost processing unit 310 may determine a second cost for the second distance of “2 miles” as “USD 4” for the first commuter “Commuter-1.” Thus, the second transceiver 306 may transmit information associated with the second cost

$$( i . e . , USD \frac{4}{2} = USD per mile )$$

to the user-computing device 102 associated with the first commuter “Commuter-1.”

For the real-time transmission of the third cost, to the second commuter “Commuter-2,” associated with the distance between the detour location and the boarding location of the second commuter, may correspond to the first cost (i.e., C^{first}). For example, the cost processing unit 310 may determine a first cost as “USD 2.” Further, the distance between the detour location and the boarding location of the second commuter “Commuter-2,” may be determined as “3 miles” (i.e., Dₐ). Thus, the second transceiver 306 may transmit information associated with the first cost (i.e., “USD 2”) to the user-computing device 102 associated with the second commuter “Commuter-2,” when the pooled vehicle (i.e., PV-1) may be travelling between the detour location and the boarding location of the second commuter “Commuter-2.” In an embodiment, the information pertaining to the third cost transmitted, to the second commuter “Commuter-2” on the user-computing device 102, between the detour location and the boarding location of the second commuter “Commuter-2” may comprise the first cost. For example, an update of the real-time cost (i.e., C_{final}) on the user-computing device 102 of the second commuter “Commuter-2” may be determined as shown by equation (20), as shown below,

C_{final}=C^{first}/Dₐ (20)

where,

C^{first}: represents a first cost (e.g., “USD 2”) incurred by the second commuter “Commuter-2” to compensate the first commuter;

Dₐ: represents a second part of the first distance (e.g., “3 miles”), i.e., between the detour location and the boarding location of the second commuter “Commuter-2”; and

C_{final}: represents the transmitted third cost (e.g., “USD 0.667 per mile”) during the travel on distance between the detour location and the boarding location of the second commuter “Commuter-2.”

Furthermore, the real-time transmission of the third cost to the second commuter “Commuter-2,” associated with the distance between the boarding location of the second commuter “Commuter-2” and the drop location of the second commuter “Commuter-2” or the first commuter “Commuter-1,” may correspond to the second cost determined for the second distance. For example, the cost processing unit 310 may determine a second cost for the second distance of “2 miles” as “USD 4” for the second commuter “Commuter-2.” Thus, the second transceiver 306 may transmit information associated with the second cost

$$( i . e . , USD \frac{4}{2} = USD per mile )$$

to the user-computing device 102 associated with second commuter “Commuter-2.”

A person having ordinary skill in the art will understand that the first commuter “Commuter-1” and the second commuter “Commuter-2” travelling in the pooled vehicle (i.e., PV-1) may or may not have the same drop location.

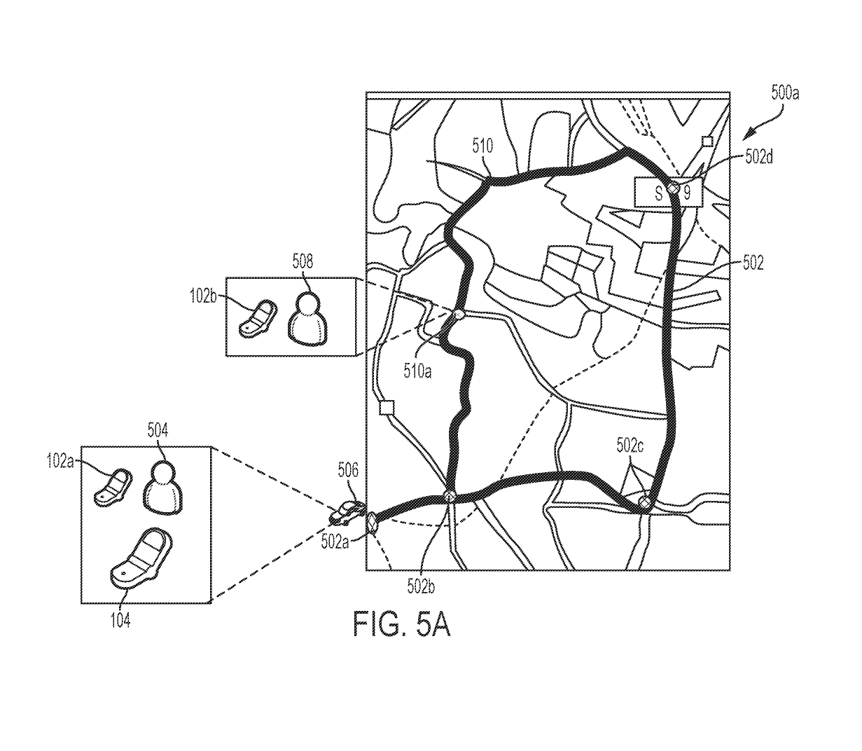

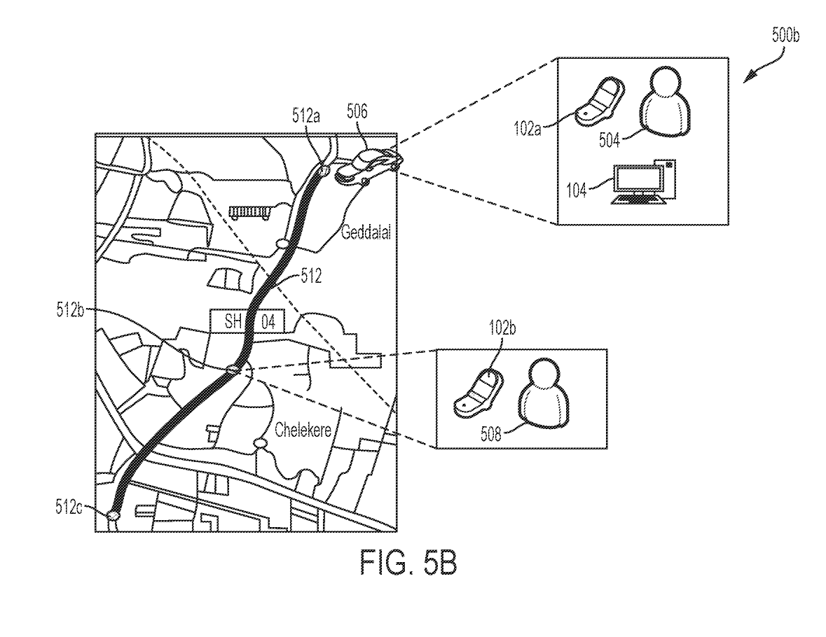

In an embodiment, various exemplary scenarios depicting the method of cost sharing in the pooled vehicle (i.e., PV-1) have been described later in FIG. 5A and FIG. 5B.

FIG. 5A and FIG. 5B are exemplary scenarios that illustrate the method of cost sharing in a pooled vehicle, in accordance with at least one embodiment. FIGS. 5A and 5B have been described in conjunction with FIGS. 1-4.

With reference to FIG. 5A, there is shown an exemplary scenario 500a comprising a first route 502 (e.g., “A->B->C->D”). One or more nodes in the first route 502 may be represented by “A” 502a, “B” 502b, “C” 502c, and, “D” 502d. A first commuter 504 associated with a user-computing device 102a may be commuting on a pooled vehicle 506 along the first route 502. The first commuter 504 may have boarded the pooled vehicle 506 from a source node (e.g., “A” 502a) to reach a destination node (e.g., “B” 502d). In an embodiment, a base fare charged by a service provider of the pooled vehicle 506 may be “USD 2 per mile.” Table 2 illustrates distances between the one or more nodes (502a, 502b, 502c, and 502d) of the first route 502.

TABLE 2
Illustrates distances between the one
or more nodes of the first route.

| One or more nodes | Distance |
|---|---|
| 502a −> 502b | 2 miles |
| 502b −> 502c | 2 miles |
| 502c −> 502d | 1 mile |

The application server 108 may receive a first travel request from a user-computing device 102b associated with a second commuter 508. The first travel request may comprise information pertaining to a source node (e.g., “E” 510a) and a destination node (e.g., “D” 502d) of the second commuter 508. The application server 108 may determine that the commuter profiles of each of the first commuter 504 and the second commuter 508 are compatible and the one or more constraints are satisfied by the first travel request. Further, the route processing unit 308 in conjunction with the cost processing unit 310 may determine that the source node 510a of the second commuter 508 satisfies the one or more routing constraints (i.e., lies in the permissible detour area associated with a current location of the pooled vehicle 506). In this scenario, the application server 108 may transmit the first travel request to a vehicle-computing device 104 associated with the pooled vehicle 506. In an embodiment, a driver of the pooled vehicle 506 may be presented a GUI to display the second user interface pertaining to the first travel request.

The route processing unit 308 may determine a second route “A->B->E->D”, i.e., 502a->502b->510a->502d for the pooled vehicle 506 to process the first travel request. Table 3 illustrates distances between one or more nodes (502a, 502b, 510a and 502c) of the second route 510.

TABLE 3
Illustrates distances between the one
or more nodes of the second route.

| One or more nodes | Distance |
|---|---|
| 502a −> 502b | 2 miles |
| 502b −> 510a | 1 mile |
| 510a −> 502d | 3 miles |

Thus, the pooled vehicle 506 may detour from “B” 502b to pick up the second commuter 508 from the source node “E” 510a. The cost processing unit 310 may determine a first cost, a second cost and a third cost for each of the first commuter 504 and the second commuter 508. Table 4 illustrates the first cost, the second cost and the third cost determined by the cost processing unit 310 for each of the first commuter 504 and the second commuter 508.

TABLE 4
Illustration of the first cost, the second cost and the third cost for each of the
first commuter and the second commuter.

| Com- | | | | |
|---|---|---|---|---|
| muter | First cost | Second cost | Third cost | Estimated cost |
| First com- muter | ${C}_{base} * ( {D}_{second route} - {D}_{first route} ) = USD 2 per mile * ( 6 miles - 5 miles ) = USD 2$ | $( {C}_{base} * ( {D}_{AD} ) / 1 ) + ( {C}_{base} * ( {D}_{DC} ) / 2 ) = USD 2 per mile * ( 3 mile ) / 1 ) + ( USD 2 per mile * ( 3 ) / 2 = USD 9$ | $second cost - first cost = USD 9 - USD 2 = USD 7$ | ${C}_{base} * {D}_{first route} = USD 2 per mile * ( 5 miles ) = USD 10$ |
| Second com- muter | ${C}_{base} * ( {D}_{second route} - {D}_{first route} ) = USD 2 per mile * ( 6 miles - 5 miles ) = USD 2$ | $( {C}_{base} * ( {D}_{DC} ) / 2 ) = ( USD 2 per mile * ( 3 ) / 2 = USD 3$ | $second cost + first cost = USD 3 + USD 2 = USD 5$ | ${C}_{base} * {D}_{DC} = USD 2 per mile * ( 3 miles ) = USD 6$ |

Prior to the detour due to the first travel request, the second transceiver 306 may be configured to transmit information pertaining to the third cost to the first commuter in real-time. In an embodiment, the information pertaining to the third cost may comprise the first part of the second cost determined for the first part of the first distance (i.e., distance between “A” 502a and “B” 502b). The cost processing unit 310 may determine the information pertaining to the third cost based on a count of commuters in the pooled vehicle 506 (i.e., one), the base fare (i.e., “USD 2 per mile”), and distance between “A” 502a and “B” 502b. The cost processing unit 310 may determine the information pertaining to the third cost to be transmitted as “USD 4” (i.e., (USD 2 per mile*2 miles)/1). In an embodiment, the user-computing device 102a may display the real-time cost updated at a rate of the base fare i.e., “USD 2 per mile” for the distance between “A” 502a and “B” 502b.

After the start of the detour, the second transceiver 306 may be configured to transmit information pertaining to the third cost to the first commuter in real-time. In an embodiment, the information pertaining to the third cost may comprise the first cost and the second part of the second cost determined for the second part of the first distance (i.e., distance between “A” 502b and “B” 510a). The cost processing unit 310 may determine the information pertaining to the third cost to be transmitted to the user-computing device 102a of the first commuter as “USD 0” (i.e., (USD 2 per mile*1 mile)−USD 2). In an embodiment, the user-computing device 102a may display the real-time cost updated at a new rate, i.e., “USD 0 per mile” for the distance between “B” 502b and “E” 510a. Further, the second transceiver 306 may be configured to transmit information pertaining to the third cost, corresponding to the first cost, to the second commuter 508 in real-time. The cost processing unit 310 may determine the information pertaining to the third cost to be transmitted to the user-computing device 102b of the second commuter. In an embodiment, the information pertaining to the third cost to be transmitted to the user-computing device 102b of the second commuter 508 may comprise the first cost “USD 2” (i.e., (USD 2 per mile*1 mile). In an embodiment, the user-computing device 102b may display the real-time cost to the second commuter 508 updated at a rate, i.e., “USD 2 per mile” for the distance between “B” 502b and “E” 510a.

After the pickup of the second commuter, the second transceiver 306 may be configured to transmit information pertaining to the third cost to the first commuter 504 in real-time. In an embodiment, the information pertaining to the third cost may comprise the second cost determined for the second distance (i.e., “E” 510a->“D” 502d). The cost processing unit 310 may determine the information pertaining to the third cost to be transmitted to the user-computing device 102a of the first commuter 504 as “USD 3” (i.e., (USD 2 per mile*3 miles)/2). In an embodiment, the user-computing device 102a may display the real-time cost updated at a rate, i.e., “USD 1 per mile” for the distance between “E” 510a and “D” 502d. Further, the second transceiver 306 may be configured to transmit information pertaining to the second cost determined for the second distance (i.e., “E” 510a->“D” 502d), to the second commuter 508 in real-time. The cost processing unit 310 may determine the information pertaining to the third cost to be transmitted to the user-computing device 102b of the second commuter 508 as “USD 3” (i.e., (USD 2 per mile*3 miles)/2). In an embodiment, the user-computing device 102b may display the real-time cost to the second commuter 508, updated at a rate, i.e., “USD 1 per mile” for the distance between “E” 510a and “D” 502d.

With reference to FIG. 5B, there is shown an exemplary scenario 500b comprising the first route 512 (e.g., “A->B->C”). One or more nodes in the first route 512 may be represented as “A” 512a, “B” 512b, and “C” 512c. The first commuter 504 associated with a user-computing device 102a may be commuting on a pooled vehicle 506 along the first route 512. The first commuter 504 may have boarded the pooled vehicle 506 from a source node 512a to reach a destination node 512c. In an embodiment, a base fare charged by the service provider of the pooled vehicle 506 may be “USD 2 per mile.”

The application server 108 may receive a second travel request from a user-computing device 102b associated with the second commuter 508. The second travel request may comprise information pertaining to a source node 512b from where the second commuter 508 may want to board the pooled vehicle 506 and a destination node 512c corresponding to a drop location of the second commuter 508. The application server 108 may determine that the commuter profiles of each of the first commuter 504 and the second commuter 508 are compatible and the one or more constraints are satisfied by the travel request. Further, the route processing unit 308 in conjunction with the cost processing unit 310 may determine that the one or more routing constraints are satisfied (i.e., the source node 512b associated with the second travel request lies in the permissible detour area associated with a current location of the pooled vehicle 506). In this scenario, the application server 108 may transmit the second travel request to the vehicle-computing device 104 associated with the pooled vehicle 506. In an embodiment, the driver of the pooled vehicle 506 may be presented a GUI to display second user interface pertaining to the second travel request.

The route processing unit 308 may determine a second route 512a->512b->512c for the pooled vehicle 506 to process the second travel request. In this scenario, since the source node 512b of the second commuter lies on the first route 512, therefore, the first route and the second route are same. Table 5 illustrates distances between one or more nodes (502a, 502b, 510a and 502c) of the second route 512.

TABLE 5
Illustrates distances between the one
or more nodes of the first route.

| One or more nodes | Distance |
|---|---|
| 512a −> 512b | 2 miles |
| 512b −> 512c | 3 miles |

In an embodiment, the cost processing unit 310 may utilize the cost per unit time parameter (e.g., “USD 1 per hour”) specified in the commuter profile of the first commuter 504 to determine the first cost incurred by the second commuter 508. The cost processing unit 310 may determine the first cost based on a detour time caused by the processing of the second travel request. In an embodiment, the detour time (e.g., “20 minutes”) may be determined based on an estimated time (e.g., “1 hour”) associated with a travel request of the first commuter.

The cost processing unit 310 may determine the first cost, the second cost and the third cost for each of the first commuter 504 and the second commuter 508. Table 6 illustrates the first cost, the second cost and the third cost determined by the cost processing unit 310 for each of the first commuter 504 and the second commuter 508.

TABLE 6
Illustration of the first cost, the second cost and the third cost for each of the
first commuter and the second commuter.

| Com- | | | | |
|---|---|---|---|---|
| muter | First cost | Second cost | Third cost | Estimated cost |
| First com- muter | ${C}_{j} * ( {Δt}_{AB} + {Δt}_{BC} - {Δt}_{estimated} ) = \frac{USD 1}{hour} * ( 20 minutes ) = USD 0.333$ | $( {C}_{base} * ( {D}_{AB} ) / 1 ) + ( {C}_{base} * ( {D}_{BC} ) / 2 = \frac{USD 2}{mile} * ( 2 miles ) / 1 ) + ( USD 2 per mile * ( 3 ) / 2 = USD 7$ | $second cost - first cost = USD 7 - USD 0.333 = USD 6.666$ | ${C}_{base} * {D}_{first route} = USD 2 per mile * ( 5 miles ) = USD 10$ |
| Sec- ond com- muter | ${C}_{j} * ( {Δt}_{AB} + {Δt}_{BC} - {Δt}_{estimated} ) = \frac{USD 1}{hour} * ( 20 minutes ) = USD 0.333$ | $( {C}_{base} * ( {D}_{BC} ) / 2 ) = ( USD 2 per mile * ( 3 ) / 2 = USD 3$ | $second cost + first cost = USD 3 + USD 0.333 = U SD 3.333$ | ${C}_{base} * {D}_{DC} = USD 2 per mile * ( 3 miles ) = USD 6$ |

Prior to processing the second travel request, the second transceiver 306 may be configured to transmit information pertaining to the third cost to the first commuter 504 in real-time. In an embodiment, the information pertaining to the third cost may comprise the second cost determined for the first distance (i.e., 512a->512b). The cost processing unit 310 may determine the information pertaining to the third cost based on a count of commuters in the pooled vehicle (i.e., one), the base fare (i.e., “USD 2 per mile”), and distance between 512a and 512b. The cost processing unit 310 may determine the information pertaining to the third cost to be transmitted as “USD 4” (i.e., (USD 2 per mile*2 miles)/1). In an embodiment, the user-computing device 102a may display the real-time cost updated at a rate of the base fare, i.e., “USD 2 per mile” for the distance between 502a and 502b.

After the pickup of the second commuter 508 from the source node 502b, the second transceiver 306 may be configured to transmit information pertaining to the third cost to the first commuter 504 in real-time. In an embodiment, the information pertaining to the third cost may comprise the first cost and the second cost determined for the second distance (i.e., distance between 502b and 502c). The cost processing unit 310 may determine the information pertaining to the third cost to be transmitted to the user-computing device 102a of the first commuter 504 as “USD 2.666” (i.e., (USD 2 per mile*3 miles)/2)−USD 0.333). In an embodiment, the user-computing device 102a may display the real-time cost updated at a rate, i.e., “USD 0.889 per mile” for the distance between 502b and 502c. Further, the second transceiver 306 may be configured to transmit information pertaining to the third cost to the second commuter in real-time. In an embodiment, the information pertaining to the third cost may comprise the first cost and the second cost determined for the second distance (i.e., distance between 502b and 502c). The cost processing unit 310 may determine the information pertaining to the third cost to be transmitted to the user-computing device 102b of the second commuter 508 as “USD 3.333” (i.e., ((USD 2 per mile*3 miles)/2)+USD 0.333). In an embodiment, the user-computing device 102b may display the real-time cost updated at a rate, i.e., “USD 1.111 per mile” for the distance between 502b and 502c.

A person having ordinary skill in the art will understand that the abovementioned exemplary scenarios are for illustrative purposes and should not be construed limiting to the scope of disclosure. In an alternate embodiment, the cost processing unit 310 may determine the first cost based on each of the detour time and detour distance.

Further, the scope of the disclosure is not limited to the first commuter and the second commuter having same destination node. In an alternate embodiment, the destination node of the first commuter and the second commuter may be different.

FIG. 6 is a block diagram that illustrates a first exemplary Graphical User-Interface (GUI) 600 presented to the commuter on the user-computing device 102 for raising a travel request, in accordance with at least one embodiment. FIG. 6 has been explained in conjunction with FIGS. 1-4.

The GUI 600 may be displayed on a display screen 602 of a user-computing device 102 associated with a commuter who may want to raise the travel request. The commuter may be required to be logged into the pooled transportation service platform by inputting his/her commuter identifier and password. In an embodiment, the pooled transportation platform may be associated with the service provider of the one or more pooled vehicles. The second processor 302 may present the GUI 600 on the user-computing device 102, when the commuter has logged in. In an embodiment, the GUI 600 may comprise a travel request window 604. The travel request window 604 may comprise a first tab 606, “SOURCE STATION.” The commuter may click on the first tab 606, “SOURCE STATION,” to input the source node. Further, the commuter may click on a second tab 608, “DESTINATION STATION,” to input the destination node. Thereafter, the commuter may click on a third tab 610, “TIME AND DAY OF TRAVEL,” to input the time and the day of travel. Thereafter, the commuter may submit the travel request by clicking on a fourth tab 612, “SUBMIT.” After submitting the travel request, the commuter may receive the first user interface from the application server 108 on the user-computing device 102.

FIGS. 7A and 7B, collectively, represents a block diagram that illustrates a second exemplary Graphical User-Interface (GUI) 700 presented to the commuter on a user-computing device 102 for displaying the first user interface, in accordance with at least one embodiment. FIGS. 7A and 7B have been explained in conjunction with FIGS. 1-4.

In an embodiment, the GUI 700 may be associated with the first user interface transmitted to the user-computing device 102 associated with the commuter (i.e., the first commuter and/or the second commuter). In order to view the first user interface displayed on a display screen, the commuter associated with the user-computing device 102 may be required to login to the pooled vehicle transportation service platform by inputting a commuter identifier and a password in input boxes 702 and 704, respectively.

After the login, the commuter may be presented with the first user interface 706 on the display screen of the user-computing device 102. The first user interface 706 may comprise a first section 708 and a second section 710. The first section 708 may comprise a commuter identifier, such as “COMMUTER-1” associated with the commuter. The second section 710 may present a first tab 710a, “ESTIMATED ARRIVAL TIME,” a second tab 710b, “ESTIMATED COST,” a third tab 710c, “ROUTE INFORMATION,” and a fourth tab 710d, “REAL-TIME COST.”

In an embodiment, the commuter may click on the first tab 710a, “ESTIMATED ARRIVAL TIME,” to view the estimated arrival time associated with the pooled vehicle. In an embodiment, the commuter may click on the second tab 710b, “ESTIMATED COST,” to view the estimated cost associated with the travel request. In an embodiment, the commuter may click on the third tab 710c, “ROUTE INFORMATION,” to view information 712 pertaining to the route associated with the travel request. The route information 712 may present a geographical map 712a of the route and a section 712b that indicates an estimated time of travel associated with the route, such as “ESTIMATED TIME: 2 HOURS.” Further, the commuter may be able to track the current location 712c of the pooled vehicle while travelling in the pooled vehicle on the geographical map 712a of the route. In an embodiment, the commuter may click on the fourth tab 710d, “REAL-TIME COST,” to view the information pertaining to an interface 714, “REAL-TIME COST,” which corresponds to real-time cost incurred by the commuter during the travel in the pooled vehicle. In an embodiment, the fourth tab 710d, “REAL-TIME COST,” may be inactive before the commuter is picked up by the pooled vehicle or before the detour of the pooled vehicle to pick up the commuter. Further, the fourth tab 710d, “REAL-TIME COST” may become active only after the commuter is picked up by the pooled vehicle or after the pooled vehicle has detoured to pick up the commuter. The interface 714, “REAL-TIME COST,” may display a first graphical and/or textual indication 714a of the real-time cost, i.e., the third cost. The interface 714, “REAL-TIME COST,” may display a second graphical and/or textual indication 714b of real-time saving. The first graphical and/or textual indication 714a and/or the second graphical and/or textual indication 714b may be updated in real-time as the commuter progresses along the route.

FIG. 8 is a block diagram that illustrates a third exemplary Graphical User-Interface (GUI) 800 presented to the operator of the pooled vehicle on a vehicle-computing device 104 for displaying the second user interface, in accordance with at least one embodiment. FIG. 8 has been explained in conjunction with FIGS. 1-4.

In an embodiment, the GUI 800 may be associated with the second user interface transmitted to the vehicle-computing device 104 associated with the pooled vehicle. In order to view the second user interface the driver of the pooled vehicle may be required to login by inputting an operator identifier and a password in input boxes 802 and 804, respectively.

After the login, the driver may be presented with the second user interface 806 on a display screen of the vehicle-computing device 104. The second user interface 806 may comprise a first section 808 and a second section 810. The first section 808 may comprise the operator identifier, such as “OPERATOR-1” associated with the driver. The second section 810 may present a geographical map 810a of a route 810b based on the travel request of the one or more commuters. Pickup locations, such as 810c and 810d, and a drop location, such as 810e, associated with the travel request of each of the one or more commuters may be presented on the geographical map 810a. In an embodiment, the second section 810 may further comprise a first button 810f, “ACCEPT,” and a second button 810g, “DECLINE.” The driver may click on the first button 810f, “ACCEPT,” if the driver wants to accept the travel request. The driver may click on the second button 810g, “DECLINE,” if the driver wants to reject the travel request. In an embodiment, if the driver may click on the second button 810g, “DECLINE,” the application server 108 may transmit the travel request to another vehicle-computing device associated with another pooled vehicle.

FIGS. 9A and 9B, collectively, represents a block diagram that illustrates a fourth exemplary Graphical User Interface (GUI) 900 presented to the service provider of the pooled vehicle on an agent-computing device for displaying a third user interface, in accordance with at least one embodiment. FIGS. 9A and 9B have been explained in conjunction with FIGS. 1-4.

In an embodiment, the GUI 900 may be associated with the third user interface transmitted to the agent-computing device (not shown) associated with the service provider of the pooled vehicle. In order to view the third user interface the service provider of the pooled vehicle may be required to login by inputting a service identifier and a password.

After the login, the service provider may be presented with the third user interface 902 on a display screen of the agent-computing device. The third user interface 902 may comprise a first section 904 and a second section 906. The first section 904 may present a geographical map 908 displaying one or more routes, a status and count of one or more currently running pooled vehicles, such as 908a, 908b, and 908c, on the one or more routes, associated with the service provider. The second section 906 may further present one or more options to the service provider. The one or more options may comprise a first option 906a, “CHOOSE CITY,” and a second option 906b, “POOLED VEHICLE TYPES.” The service provider may choose a city from a drop down list in the first option 906a, “CHOOSE CITY.” Further, the service provider may further choose a pooled vehicle type, such as 906c, 906d, or 906e in the second option 906b, “POOLED VEHICLE TYPES.” The service provider may select a currently running pooled vehicle by clicking on 908a, 908b or 908c to view GUI 910 comprising information pertaining to the currently running pooled vehicle. The information pertaining to the currently running pooled vehicle may comprise a route 910a of the currently running pooled vehicle, a permissible detour area 910b associated with the route 910a of the currently running pooled vehicle. The service provider of the pooled vehicle may make manual changes in the status of the currently running pooled vehicle. In an embodiment, the manual changes may comprise adding or removing of commuters from the currently running pooled vehicle.

A person having ordinary skill in the art will understand that the abovementioned exemplary scenario is for illustrative purpose and should not be construed to limit the scope of the disclosure.

The disclosed embodiments encompass numerous advantages. The disclosure provides a method of cost sharing in a pooled vehicle. The disclosed method and system provides a method for compensating a first commuter travelling in the pooled vehicle for an inconvenience caused by a processing of a travel request by a second commuter. The inconvenience may be determined as a detour distance and/or a detour time associated with the travel request of the second commuter. Further, the disclosed method and system utilizes a first cost, determined based on the detour distance and/or the detour time, incurred by the second commuter to compensate the first commuter. A second cost is as also determined based on distance traveled by the first commuter in the pooled vehicle and a count of the second commuters in the pooled vehicle along the corresponding distance. Further, the disclosed method and system utilizes a real-time transmission of a third cost, determined based on the second cost and the first cost to each of the first commuter and the second commuter. Thus, the user-computing device associated with the commuter may display a real-time cost incurred by the commuter as the commuter progresses along the route in the pooled vehicle. Also, the disclosed method and the system provides a Graphical User Interface (GUI) to a service provider of the pooled vehicle that may display a current location of currently running pooled vehicles on a geographical map.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for cost sharing in a pooled vehicle have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method of cost sharing in a pooled vehicle, the method comprising:
receiving, by one or more transceivers of a computing device, a detour distance to be traversed by the pooled vehicle to process a travel request, wherein the detour distance is determined by one or more sensors in the pooled vehicle; and
determining, by one or more processors of the computing device, a first cost to be compensated to at least one first commuter in the pooled vehicle based on the received detour distance, wherein the first cost is incurred by a second commuter associated with the travel request.

2. The method of claim 1, further comprising determining, by the one or more processors of the computing device, a second cost incurred by the first commuter based on a first distance between a first node corresponding to a boarding location of the first commuter, and a second node corresponding to a boarding location of the second commuter.

3. The method of claim 2, wherein the second cost incurred by the first commuter is further determined based on a second distance between the second node, and a third node corresponding to a drop location of the second commuter or the first commuter.

4. The method of claim 3, further comprising determining, by the one or more processors of the computing device, the second cost incurred by the second commuter based on the second distance between the second node and the third node.

5. The method of claim 4, further comprising determining, by the one or more processors of the computing device, a third cost incurred by the first commuter and the second commuter based on the corresponding first cost and the corresponding second cost.

6. The method of claim 5, further comprising transmitting, by the one or more transceivers of the computing device, the third cost to a user-computing device associated with each of the first commuter and the second commuter, wherein the transmission is in real-time, wherein a real-time update of the third cost is rendered on a graphical user interface of the user-computing device.

7. The method of claim 1, further comprising processing, by the one or more transceivers of the computing device, the travel request received from the second commuter based on a commuter profile of each of the first commuter and the second commuter and one or more constraints defined by a service provider, wherein the service provider is associated with the pooled vehicle.

8. The method of claim 7, wherein the commuter profile comprises at least a preference of one or more co-commuters, a first detour distance threshold, a cost per unit time parameter, a first waiting time threshold, or a maximum count of intermediate hops.

9. The method of claim 8, wherein the determination of the first cost is further based on the cost per unit time parameter in the commuter profile of the first commuter.

10. The method of claim 7, wherein the one or more constraints comprise one or both of a second detour distance threshold and a second waiting time threshold.

11. The method of claim 1, further comprising transmitting, by the one or more transceivers of the computing device, an estimated cost to a user-computing device associated with a commuter, when a travel request for the pooled vehicle, is received from the user-computing device associated with the commuter, wherein the commuter corresponds to the first commuter or the second commuter.

12. The method of claim 11, wherein the estimated cost is determined based on a distance associated with the travel request for the pooled vehicle and a count of one or more commuters in the pooled vehicle.

13. The method of claim 11, wherein a third cost incurred by the commuter is either less than or equal to the corresponding estimated cost.

14. The method of claim 1, further comprising receiving, by the one or more transceivers of the computing device, a detour time consumed to process the travel request, wherein the detour time is determined by the one or more sensors installed in the pooled vehicle, wherein the first cost is determined based on the detour time.

15. A system for cost sharing in a pooled vehicle, the system comprising:
one or more processors configured to:
operate one or more transceivers of a computing device to receive a detour distance to be traversed by the pooled vehicle to process a travel request, wherein the detour distance is determined by one or more sensors in the pooled vehicle; and
determine a first cost to be compensated to at least one first commuter in the pooled vehicle based on the received detour distance, wherein the first cost is incurred by a second commuter associated with the travel request.

16. The system of claim 15, wherein the one or more processors of the computing device are configured to determine a second cost incurred by the first commuter based on a first distance between a first node corresponding to a boarding location of the first commuter, and a second node corresponding to a boarding location of the second commuter.

17. The system of claim 16, wherein the second cost incurred by the first commuter is further determined based on a second distance between the second node, and a third node corresponding to a drop location of the second commuter or the first commuter.

18. The system of claim 17, wherein the one or more processors of the computing device are further configured to determine the second cost incurred by the second commuter based on the second distance between the third node and the fourth node.

19. The system of claim 18, wherein the one or more processors of the computing device are further configured to determine a third cost incurred by the first commuter and the second commuter based on the corresponding first cost and the corresponding second cost.

20. A computer program product for use with a computer, the computer program product comprising a non-transitory computer readable medium, wherein the non-transitory computer readable medium stores a computer program code for cost sharing in a pooled vehicle, wherein the computer program code is executable by one or more processors of a computing device to:
operate one or more transceivers to receive a detour distance to be traversed by the pooled vehicle to process a travel request, wherein the detour distance is determined by one or more sensors in the pooled vehicle; and
determine a first cost to be compensated to at least one first commuter in the pooled vehicle based on the received detour distance, wherein the first cost is incurred by a second commuter associated with the travel request.
